(19) United States
(12) Patent Application Publication
(10) Pub. No.: US 2022/0049483 A1
(43) Pub. Date: Feb. 17, 2022

(54) PERSONAL HYGIENE WASHING DEVICES, SYSTEMS, METHODS AND KITS

(71) Applicant: MAKE THE WORLD LESS CRAPPY, INC., Chicago, IL (US)

(72) Inventors: Luke MONTGOMERY, Chicago, IL (US); Barthelemy MENAYAS, Chicago, IL (US)

(73) Assignee: MAKE THE WORLD LESS CRAPPY, INC., Chicago, IL (US)

(21) Appl. No.: 17/403,323

(22) Filed: Aug. 16, 2021

Related U.S. Application Data
(60) Provisional application No. 63/066,355, filed on Aug. 17, 2020.

(51) Int. Cl. E03D 9/08; B05B 7/04

(52) U.S. Cl. CPC E03D 9/085; B05B 7/0408

(57) ABSTRACT

Disclosed are systems, devices, methods and kits, for adapting a standard toilet that works with an existing water supply and/or plumbing to provide the functionality of a bidet. Additionally, disclosed are solution delivery systems operable to deliver a soap-free, zero residue cleaning agent. Also disclosed are fluid delivery devices that provides improved control of a stream of fluid from a bidet system that targets the anatomical area of interest.

### CROSS-REFERENCE

This application claims the benefit of U.S. Provisional Application No. 63/066,355, filed Aug. 17, 2020, entitled Personal Hygiene Washing Devices, Methods and Kits, which application is incorporated herein in its entirety by reference.

### BACKGROUND

### Field

Sanitary washing apparatuses, systems, methods, and kits for the anal and genitalia anatomy.

Maintaining cleanliness of the anal and genital areas is a problem as old as time. The bidet dates back to use in France in the 1600s and provided a wash basin which was used as a second step to the use of a chamber pot. Standalone bidets are still popular in Italy, Portugal, Japan, Argentina and Venezuela.

During the U.S. Civil War, President Lincoln and his Cabinet used then groundbreaking Gayetty's Medicated Paper in the water closet (i.e., when using the toilet). The next noteworthy improvement occurred when Wheeler invented perforated paper on a roll (U.S. Pat. No. 465,588) in 1891. Starting in the 1880s flush toilets (known as water closets) were also introduced in the homes of the wealthy and hotels. Still, as late as 1940 nearly half of the houses in the US lacked hot piped water, a bathtub or shower, or a flush toilet.

As indoor plumbing became increasingly common, more and more homes installed toilets. While bidets are more hygienic than standard toilet paper, the widespread adoption of the bidet has lagged. The lag in the adoption of bidets in the US is likely influenced by the fact that bidets are typically stand-alone devices not easily retrofitted into many homes and facilities. In order to overcome the retrofitting issue, bidet attachments (e.g., bidet toilet seat adapters) have been developed for use with a standard toilet. However, the bidet adapters do not deliver the same level of cleanliness that a standalone bidet delivers. Neither the adaptive or stand-alone bidet provide a targeted spray that focuses fluid application to a specific area of interest, or a fluid that contains a cleaning agent.

As the world comes to terms with the ubiquitous nature of germ transmission following, for example, the COVID-19 pandemic, awareness of the importance of hygiene has increased. Additionally, as younger generations desire to reduce negative impacts on the environment caused by various activities of modern life, awareness of the impact toilet paper has on deforestation and the amount of energy and water required to make a single roll of toilet paper has become a pressing environmental issue for many.

What is needed are systems, devices, methods, and kits for adapting a standard toilet that works with the existing water supply to provide the functionality of a bidet that also has the hygienic features of a bidet. Additionally, what is needed are solutions that provide a soap-free, zero residue cleaning agent. Lastly what is needed is a way to provide an improved fluid spray that accurately targets the anatomical area of interest.

### SUMMARY

Disclosed are systems, devices, methods and kits, for adapting a standard toilet that works with an existing water supply and/or plumbing to provide the functionality of a bidet. Additionally, a solution delivery system is disclosed delivered to provide a soap-free, zero residue cleaning agent. Also disclosed is a fluid delivery device that provides improved control of a stream of fluid from a bidet system that targets the anatomical area of interest including the genitalia, perineum, and anus.

An aspect of the disclosure is directed to hygiene washing systems. Suitable systems comprise: a mixing pod, the mixing pod further comprising a mixing pod housing having an interior chamber, a mixing pod inlet, and a mixing pod outlet, a mixing pod controller, a venturi injector in communication with a mixing pod valve, and an insertion member operable to insert a concentrate into the interior chamber; a fluid applicator, the fluid applicator further comprising a body having a fluid applicator length, a fluid applicator width, a fluid applicator thickness, and a fluid receiving aperture wherein the fluid applicator length is greater than the fluid applicator width, a tubular member in fluid communication with the mixing pod and the body, and a fluid delivery aperture operable to deliver fluid from the fluid applicator when a fluid applicator controller is engaged; and an adapter, wherein the adapter is operable to connect the mixing pod to a water source. The fluid applicator can have an overall 3-dimensional rectangular shape with curved sides. Additionally, the tubular member can be unidirectional. In at least some configurations, the fluid delivery aperture can have a triangular aperture with concave sides. The fluid applicator controller can also be configured to fit within a channel in the fluid applicator aperture. The fluid applicator body can have a front piece and a back piece wherein the front piece and the back piece have a snap-fit arrangement. The body can further comprise one or more of an inlet in communication with the tubular member and a magnet. In some configurations, a dryer is provided that is operable to deliver air via at least one of the fluid delivery aperture and an air delivery aperture. A power source can also be provided, such as a battery and/or a turbine. A heater can also be provided that is operable to heat fluid prior to delivery via the fluid delivery aperture. The system can include an adapter operable to connect a water supply line to the mixing pod. The adapter can further comprises a female adapter attachment with an inlet screw knob, a male adapter attachment, and a valve state indicator. A docking station can also be provided for the fluid applicator having a housing with a front surface and a rear surface. The docking station can further comprise a docking station magnet. The docking station magnet is operable to attract the fluid applicator magnet when the docking station and fluid applicator are in proximity. The docking station can also include a securement interface on the rear surface of the housing. A fluid applicator controller aperture can also be positioned along a portion of the fluid applicator length having a fluid applicator aperture width sized to receive a digit of a user. Where a fluid applicator aperture is provided a fluid applicator controller is accessible in the fluid applicator controller aperture and further wherein the fluid applicator controller moves in a proximal direction when activated by the user.

Another aspect of the disclosure is directed to mixing pods. Suitable mixing pods comprise: a mixing pod housing having an interior chamber, a mixing pod inlet, and a mixing pod outlet, a mixing pod controller, a venturi injector in communication with a mixing pod valve, and an insertion member operable to insert a concentrate into the interior chamber. The mixing pod can include a heater operable to heat fluid. Additionally, the mixing pod can be operable to maintain a fluid at a room temperature. The mixing pod housing can further comprise a mixing pod cap, a mixing pod chamber, and a mixing pod base. A column can also be provided and the mixing pod chamber can have a center tubular member that fits around the mixing pod column. The tubular member can be operable to also receive one or more tubings or tubular members. Additionally, the mixing pod base can have a base inlet aperture and a base outlet aperture and the mixing pod chamber has a chamber inlet aperture and a chamber outlet aperture and further wherein the base inlet aperture aligns with the chamber inlet aperture and the base outlet aperture aligns with the chamber outlet aperture.

Still another aspect of the disclosure is directed to fluid applicators. Suitable fluid applicators comprise: a body having a fluid applicator length, a fluid applicator width, a fluid applicator thickness, and a fluid receiving aperture wherein the fluid applicator length is greater than the fluid applicator width wherein the fluid applicator is in fluid communication with a fluid source, and a fluid delivery aperture operable to deliver fluid from the fluid applicator when a fluid applicator controller is engaged wherein the fluid delivery aperture is a triangular aperture with concave sides. The fluid applicator can have an overall 3-dimensional rectangular shape with curved sides. Additionally, a tubular member can be provided, such as a unidirectional tubular member. The fluid applicator controller can be configured to fit within a channel in the fluid applicator aperture. The fluid applicator body or housing can have a front piece and a back piece wherein the front piece and the back piece have a snap-fit arrangement. Additionally, the body can further comprise an inlet in communication with the tubular member. A magnet can also be provided in some configurations. A dryer operable to deliver air via at least one of the fluid delivery aperture and an air delivery aperture can be provided in some configurations. Additionally a power source can be provided when desired, such as a battery and/or a turbine. A heater can also be provided that is operable to heat fluid prior to delivery via the fluid delivery aperture. The fluid applicator can be operable to engage a docking station having a housing with a front surface and a rear surface, such as by use of the magnet. The docking station can also have a securement interface on the rear surface of the housing. A fluid applicator controller aperture can also be provided in some configurations of the fluid applicator device. The controller is positionable along a portion of the fluid applicator length having a fluid applicator aperture width sized to receive a digit of a user. Additionally, the fluid applicator controller can be accessible in the fluid applicator controller aperture and further wherein the fluid applicator controller moves in a proximal direction when activated by the user.

Yet another aspect of the disclosure is directed to an adapter comprising: a housing wherein the housing has a female adapter attachment having an inlet screw knob, a male adapter attachment, a front surface and a rear surface, a valve positioned within the housing, an external valve controller operable to control an open-closed position of the valve, a valve state indicator, and an inlet connector, a first outlet connector, and a second outlet connector. The inlet connector and the first outlet connector can be positioned adjacent each other.

Another aspect of the disclosure is directed to an installation tool comprising: a housing having a first piece with a first piece exterior surface, a first piece interior surface, a first piece female engagement member and a first piece male engagement member a second piece with a second piece interior surface and a second piece interior surface, a second piece female engagement member operable to engage the first piece male engagement member and a second piece male engagement member operable to engage the first piece female engagement member, wherein the installation tool defines a six-sided aperture when the first piece and the second piece are secured together.

An additional aspect of the disclosure is directed to a method of installing a washing system comprising: providing the washing system wherein the washing system comprises a mixing pod, the mixing pod further comprising a mixing pod housing having an interior chamber, a mixing pod inlet, and a mixing pod outlet, a mixing pod controller, a venturi injector in communication with a mixing pod valve, and an insertion member operable to insert a concentrate into the interior chamber; a fluid applicator, the fluid applicator further comprising a body having a fluid applicator length, a fluid applicator width, a fluid applicator thickness, and a fluid receiving aperture wherein the fluid applicator length is greater than the fluid applicator width, a tubular member in fluid communication with the mixing pod and the body, and a fluid delivery aperture operable to deliver fluid from the fluid applicator when a fluid applicator controller is engaged; and an adapter, wherein the adapter is operable to connect the mixing pod to a water source. connecting the adapter to a water supply; and connecting the adapter to the mixing pod. When the device is being installed, the docking station can be adhered to a surface and the fluid applicator can removably engage the docking station.

Still another aspect of the disclosure is directed to a method of using a fluid applicator comprising: providing the fluid applicator wherein the fluid applicator comprises a body having a fluid applicator length, a fluid applicator width, a fluid applicator thickness, and a fluid receiving aperture wherein the fluid applicator length is greater than the fluid applicator width wherein the fluid applicator is in fluid communication with a fluid source, and a fluid delivery aperture operable to deliver fluid from the fluid applicator when a fluid applicator controller is engaged wherein the fluid delivery aperture is a triangular aperture with concave sides; directing the fluid delivery aperture toward a target area selected from genitalia, perineum and anus; and activating the fluid applicator to deliver a fluid to the target area. Suitable fluid includes one or more of each of a fragrance, a surfactant, a cleaning agent, an antibacterial, a scrubbing agent, an emollient, a prebiotic, and a postbiotic.

An additional aspect of the disclosure is directed to washing system kits. Suitable kits comprise: a mixing pod, the mixing pod further comprising a mixing pod housing having an interior chamber, a mixing pod inlet, and a mixing pod outlet, a mixing pod controller, a venturi injector in communication with a mixing pod valve, and an insertion member operable to insert a concentrate into the interior chamber; a fluid applicator, the fluid applicator further comprising a body having a fluid applicator length, a fluid applicator width, a fluid applicator thickness, and a fluid receiving aperture wherein the fluid applicator length is greater than the fluid applicator width, a tubular member in fluid communication with the mixing pod and the body, and a fluid delivery aperture operable to deliver fluid from the fluid applicator when a fluid applicator controller is engaged; and an adapter, wherein the adapter is operable to connect the mixing pod to a water source. One or more of an installation tool, an adapter, hoses (either unidirectional, bidirectional, or both), a docking station, and concentrates can also be provided. Suitable concentrates, can be liquid, crystals, granules, power, tablet, and/or gelatin capsules. Additionally, the concentrates can include a fragrance, a surfactant, a cleaning agent, an antibacterial, a scrubbing agent, an emollient, a prebiotic, and/or a postbiotic. The concentrate can be scented or unscented.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

DE 2510939 A1 dated Sep. 23, 1976 to Benthin;

JP 2011252311 A dated Dec. 15, 2011 to Kawamura et al.;

KR 200338303 Y1 dated Jan. 16, 2004;

U.S. Pat. No. 465,588 A dated 1891 Dec. 22 to Wheeler;

U.S. Pat. No. 4,000,742 A dated Jan. 4, 1977 to Digicomo;

U.S. Pat. No. 4,205,402 A dated Jun. 3, 1980 to Miller;

U.S. Pat. No. 4,441,219 A dated Apr. 10, 1984 to Epstein;

U.S. Pat. No. 4,807,311 A dated Feb. 28, 1989 to Ingels;

U.S. Pat. No. 5,685,028 A dated Nov. 11, 1997 to Miller et al.;

U.S. Pat. No. 5,987,659 A dated Nov. 23, 1999 to Cannizzaro;

U.S. Pat. No. 6,035,458 A dated Mar. 14, 2000 to Tarzia;

U.S. Pat. No. 6,397,406 B1 dated Jun. 4, 2002 to Moshkovich;

U.S. Pat. No. 6,671,892 B1 dated Jan. 6, 2004 to Plyant;

U.S. Pat. No. 6,941,590 B2 dated Sep. 13, 2005 to Lim;

U.S. Pat. No. 7,065,802 B2 dated Jun. 27, 2006 to Jung;

U.S. Pat. No. 7,316,038 B2 dated Jan. 8, 2008 to Egeresi;

US 2008/0134423 A1 dated Jun. 12, 2008 to Ding;

U.S. Pat. No. 7,690,392 B1 dated Apr. 6, 2010 to Sarkiss;

U.S. Pat. No. 8,505,126 B2 dated Aug. 13, 2013 to Morotomi et al.;

U.S. Pat. No. 9,074,361 B2 dated Jul. 7, 2015 to Mochita et al.;

U.S. Pat. No. 10,233,626 B2 dated Mar. 19, 2019 to OTOWA et al.;

U.S. Pat. No. 10,557,257 B1 dated Feb. 11, 2020 to Al Sabah et al.;

U.S. Pat. No. 10,604,923 B2 dated Mar. 31, 2020 to Lee et al.;

U.S. Pat. No. 10,619,336 B2 dated Apr. 14, 2020 to Jung et al.;

US 2007/0044223 A1 dated Mar. 1, 2007 to Mengistu;

US 2007/0256226 A1 dated Nov. 8, 2007 to Pinizzotto;

US 2015/0313424 A1 dated Nov. 5, 2015 to Lara;

WO 1991/003974 A1 dated Apr. 4, 1991 to Constantinos; and

WO 2020/043498 A1 dated Mar. 5, 2020 to BOUBSI.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-E illustrate a system for personal hygiene washing devices and alternative use environments;

FIGS. 2A-I illustrate an exemplar fluid applicator of a personal hygiene washing device or system;

FIGS. 3A-I illustrate a mixing pod;

FIGS. 4A-G illustrate a connector;

FIGS. 5A-G illustrate a docking station for a fluid applicator;

FIGS. 6A-D illustrate a finger wrench for use in installing a personal hygiene washing device and system;

FIGS. 7A-B illustrate a bidirectional hose suitable for connecting a mixing pod and a connector;

FIGS. 8A-B illustrate a unidirectional hose for connecting a fluid applicator to a connector; and

FIG. 9A-D illustrates a portable fluid applicator 900.

### DETAILED DESCRIPTION

### I. Systems

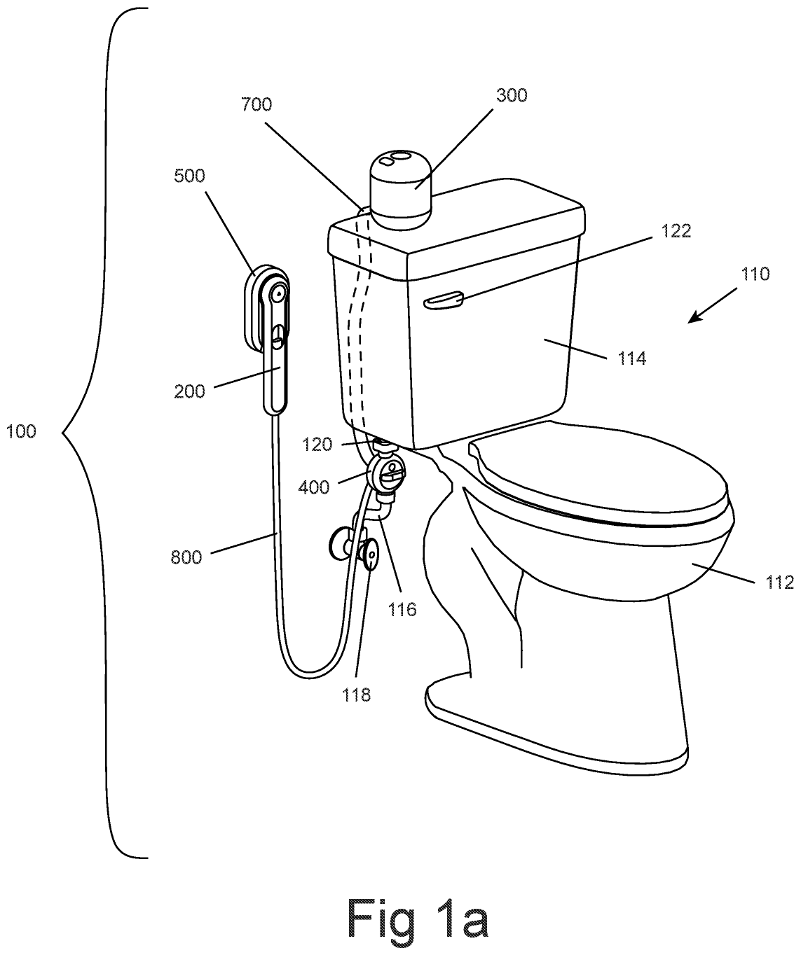

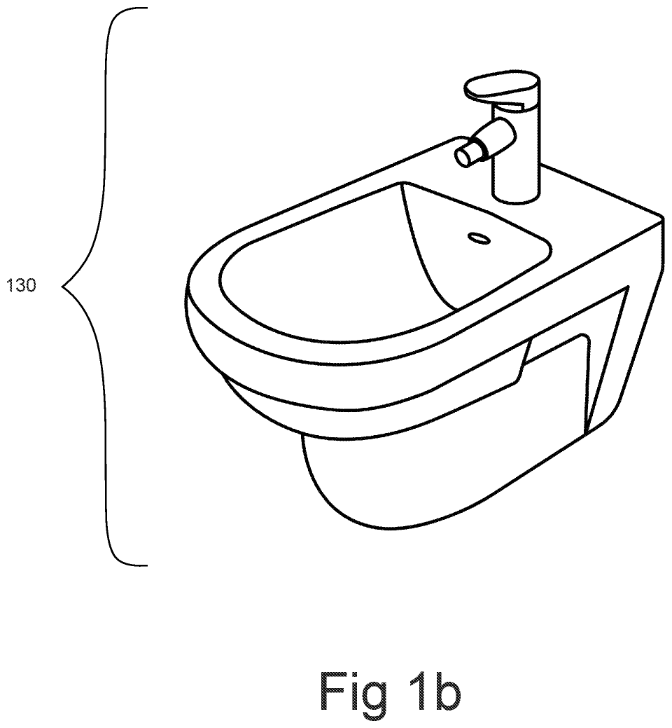

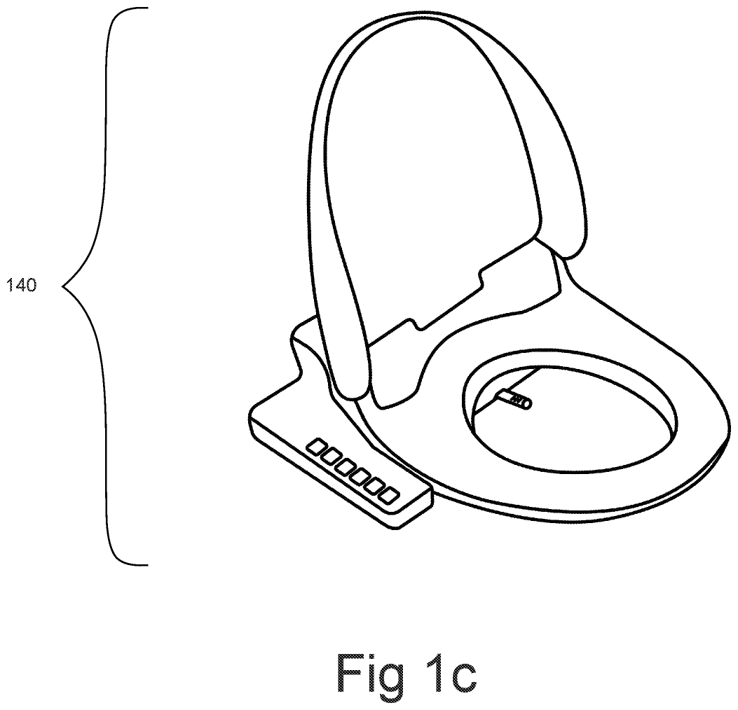

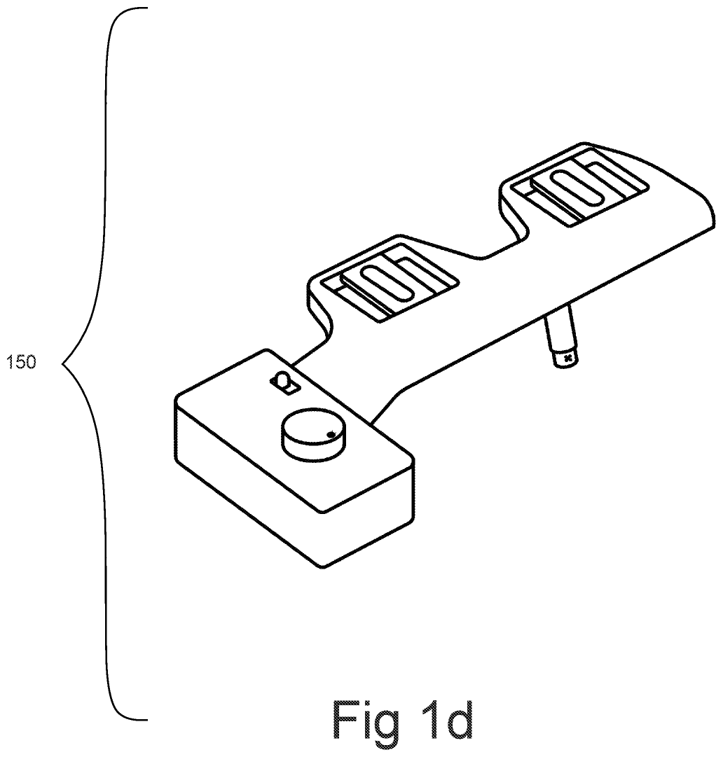

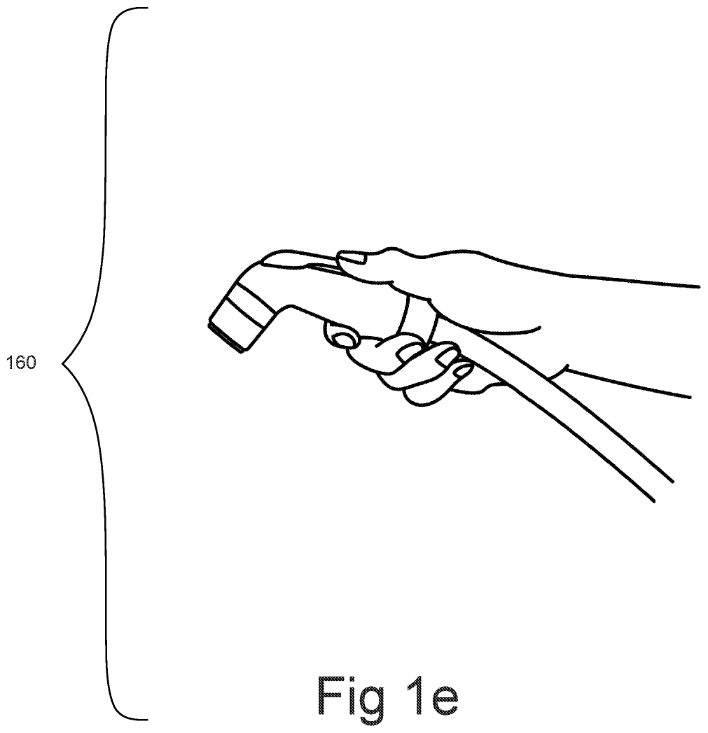

Turning now to FIG. 1A, a system 100 that includes a personal hygiene washing device is illustrated. The system 100 can include a toilet 110, such as the standard toilet illustrated. The toilet 110 can include a bowl 112, a toilet tank 114, a water supply line 116, and a shut-off valve 118. A handle 122 or button or control mechanism can be provided to control release of water from the toilet tank 114 through the bowl 112 during use, as would be appreciated by those skilled in the art.

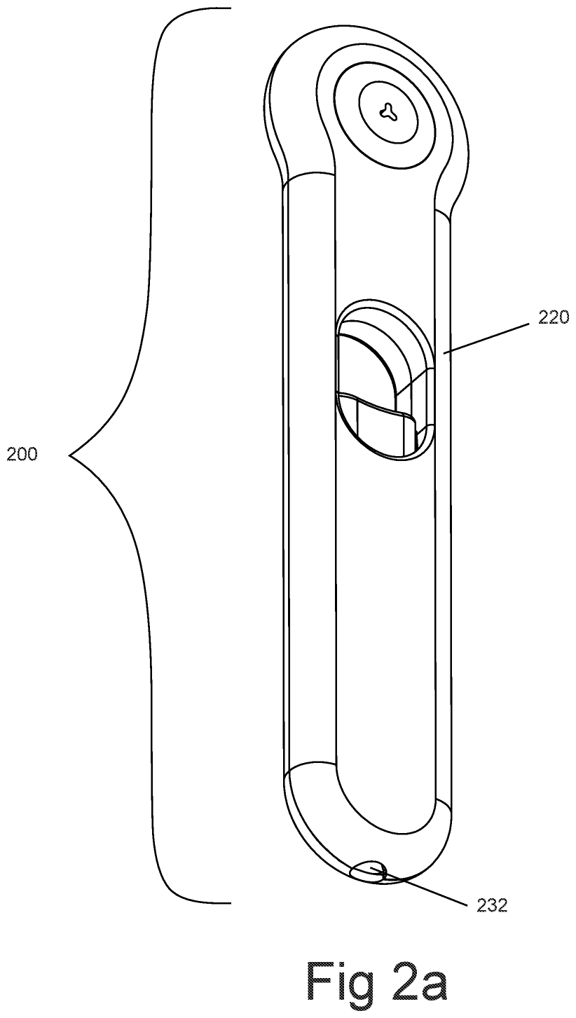

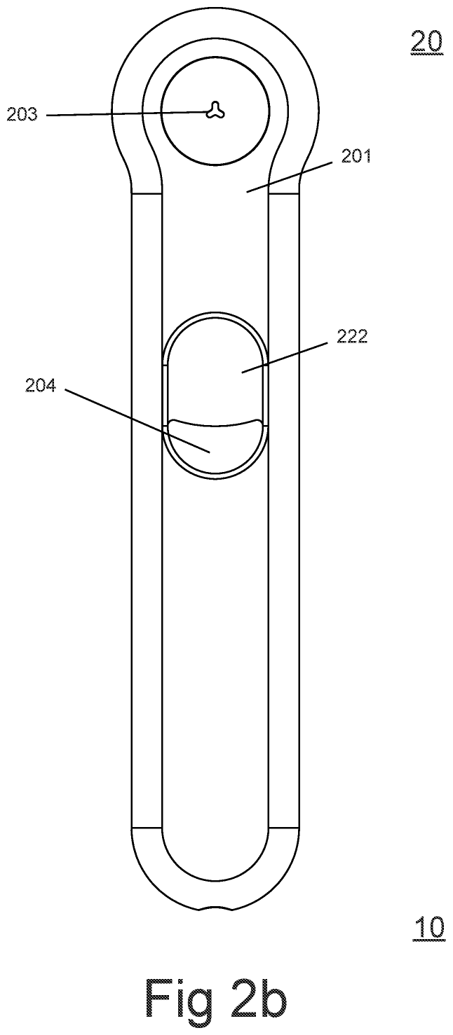

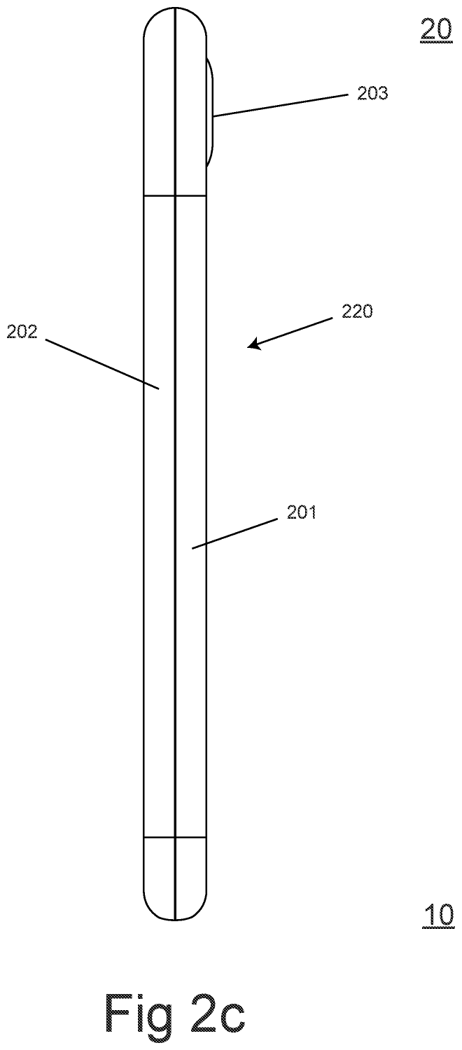

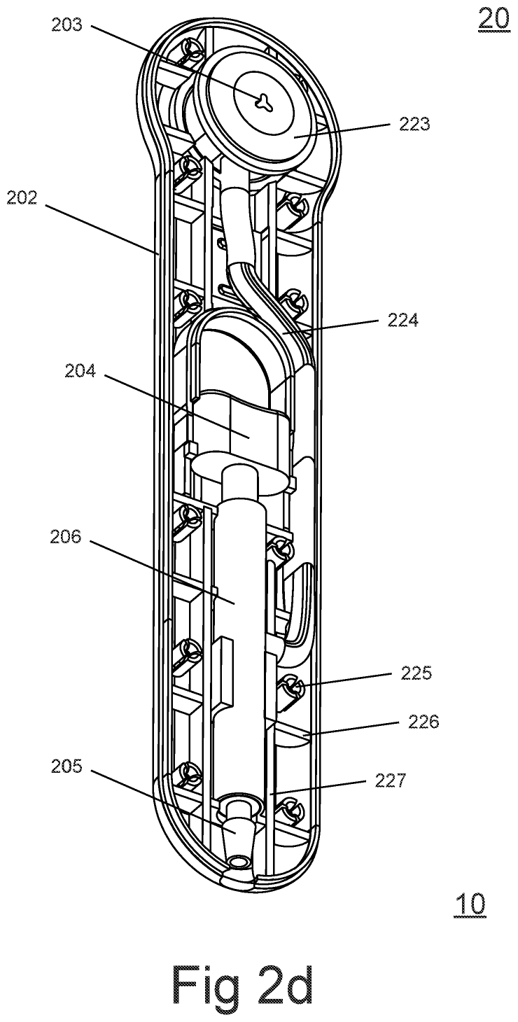

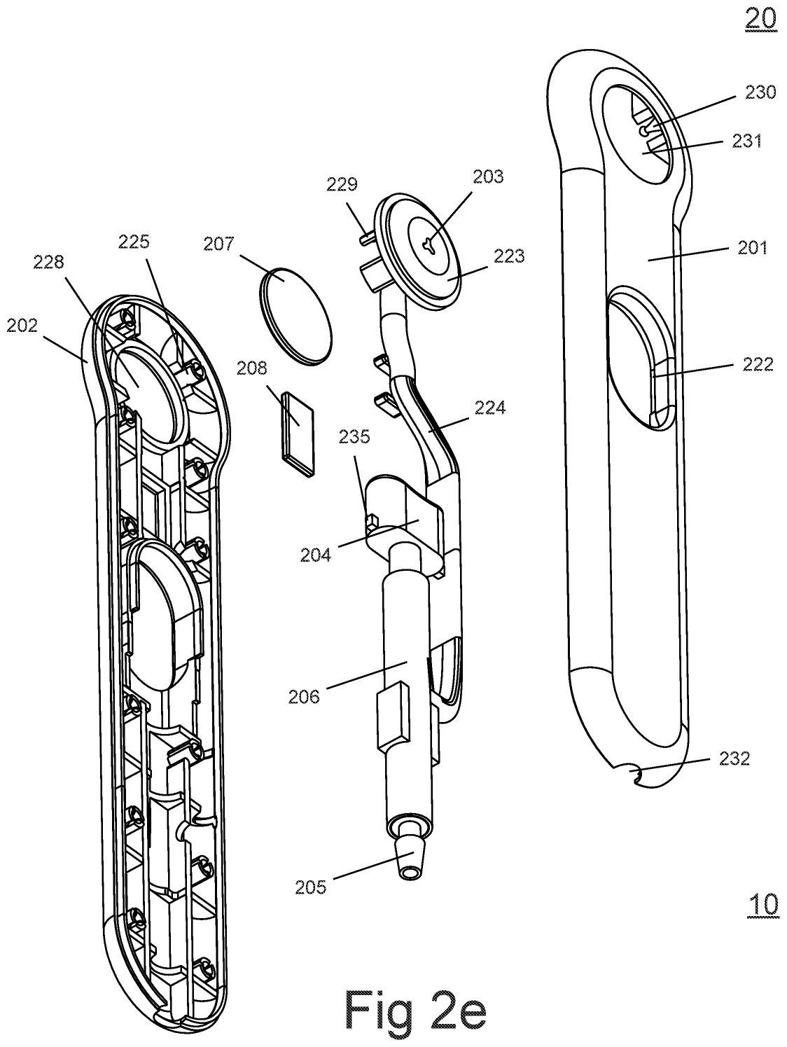

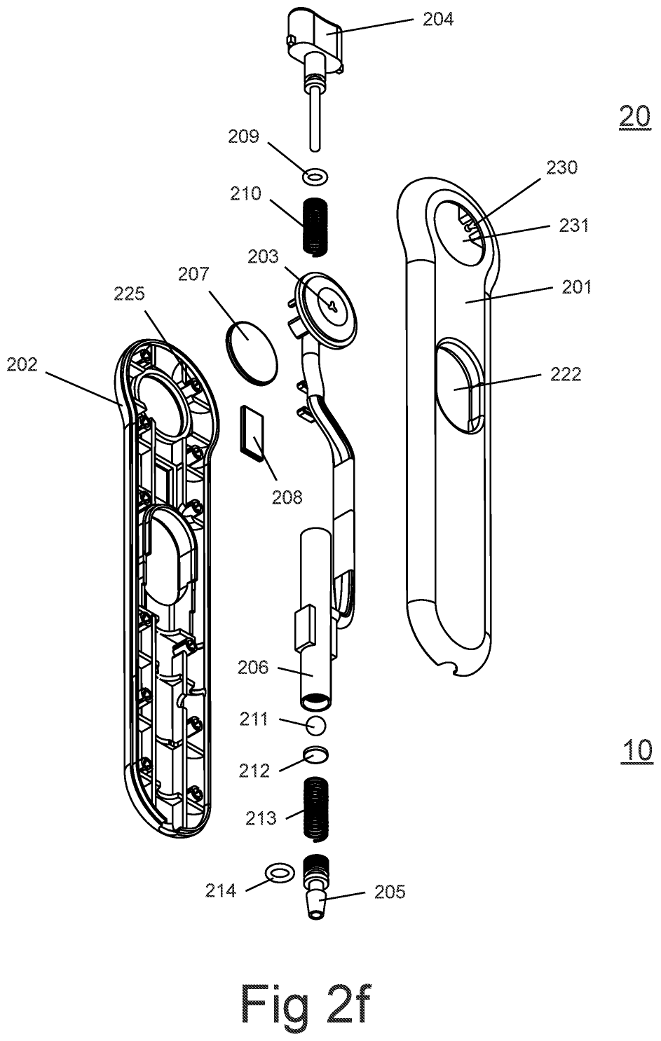

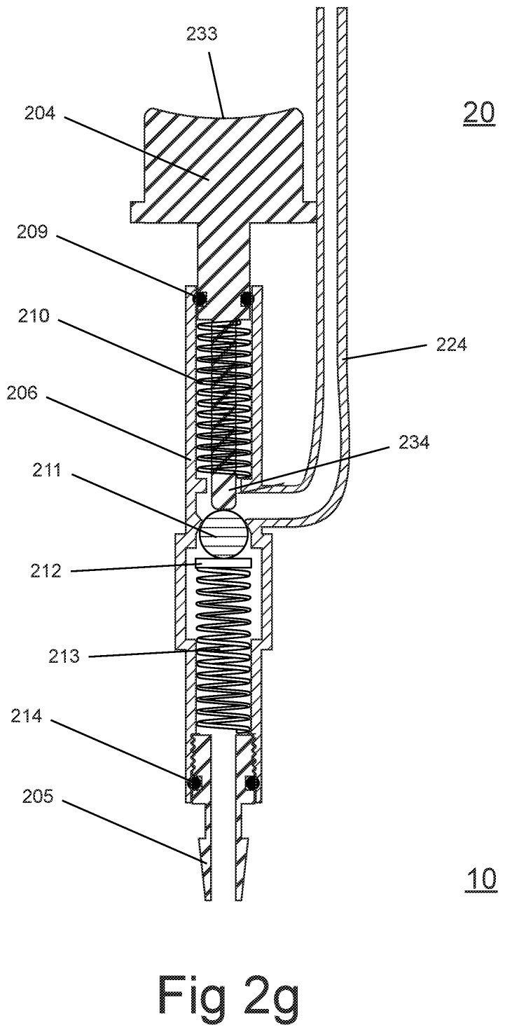

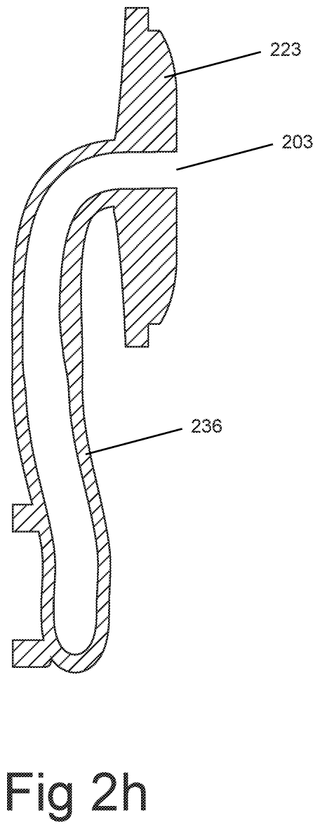

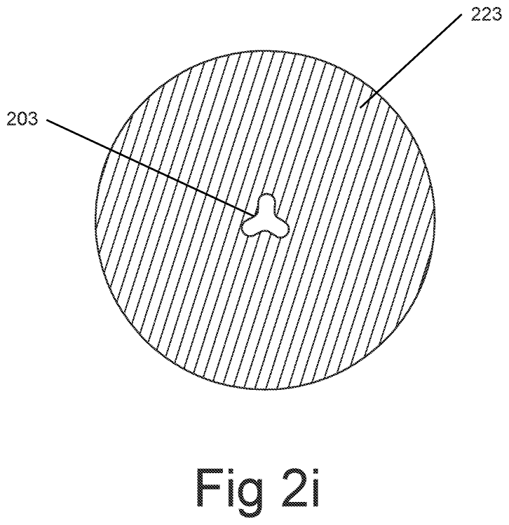

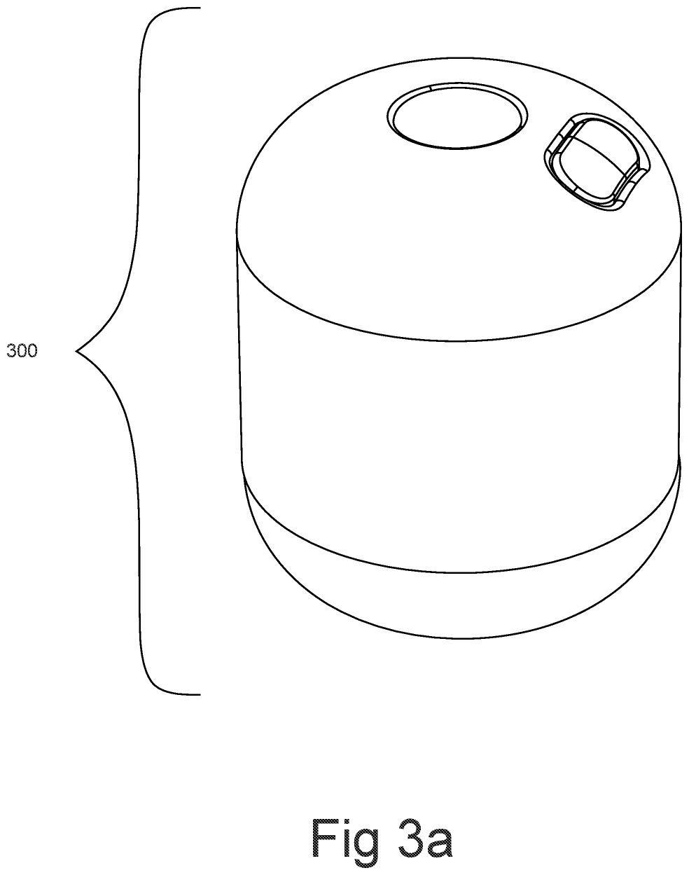

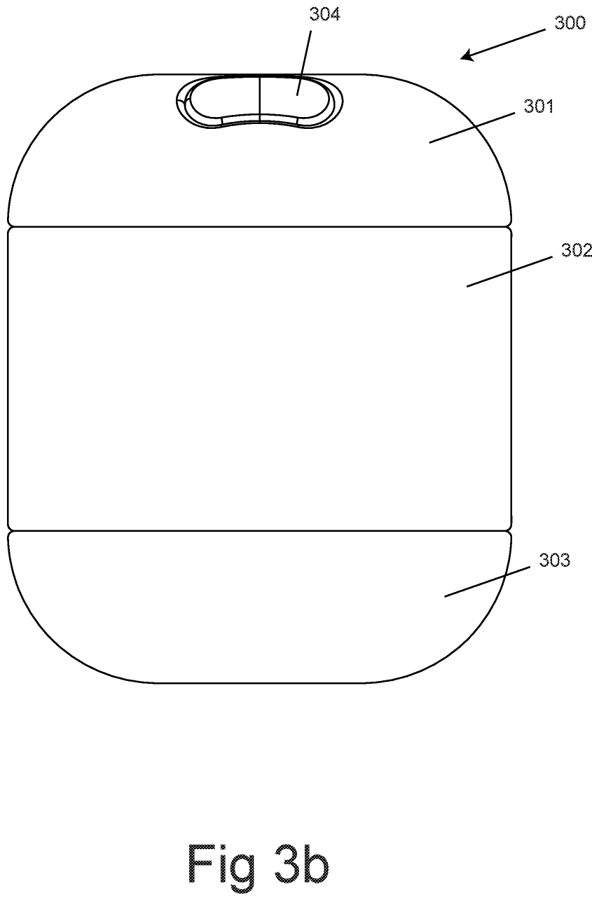

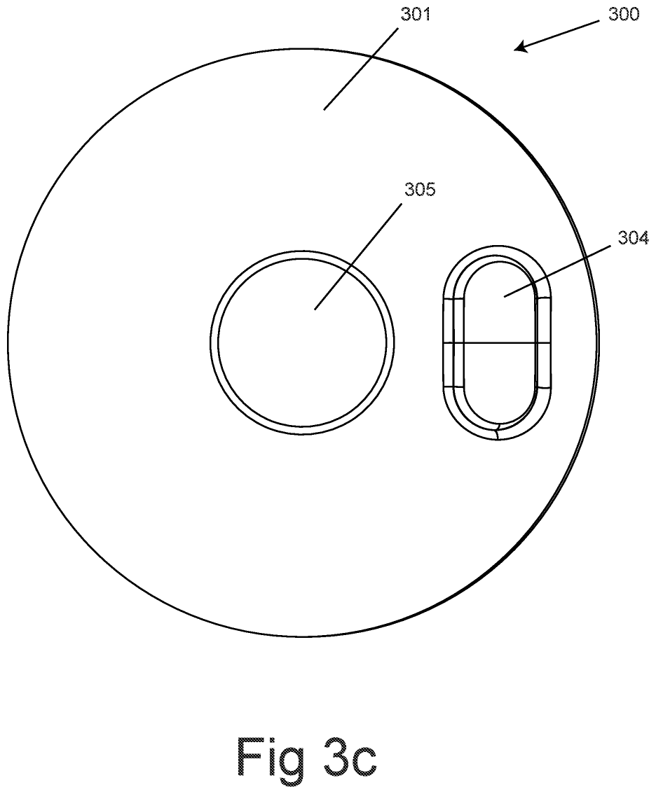

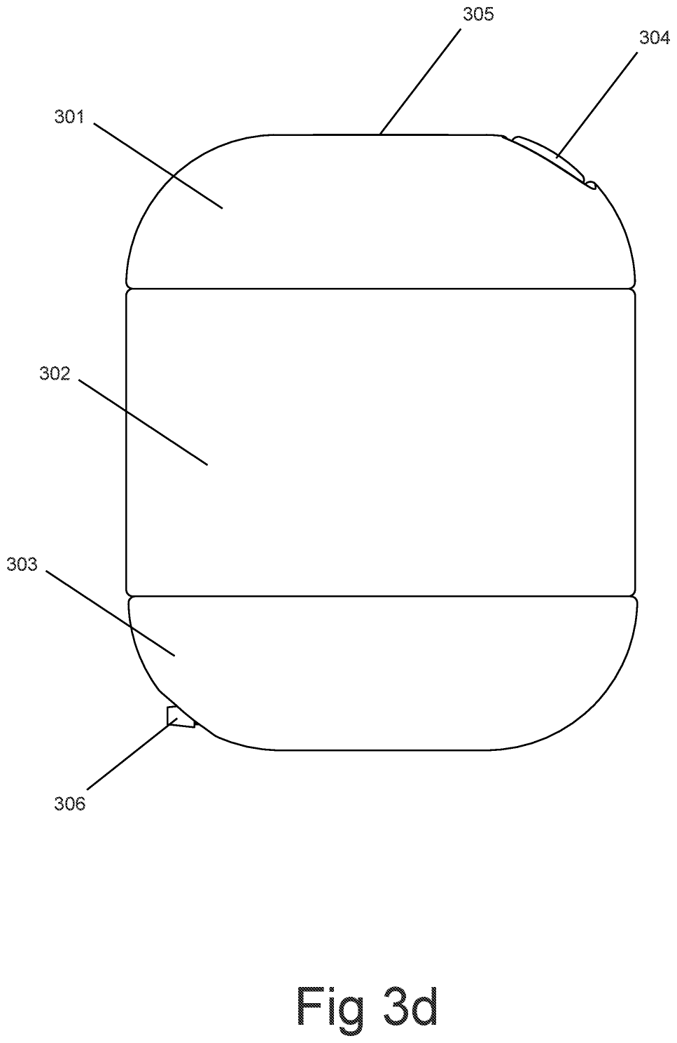

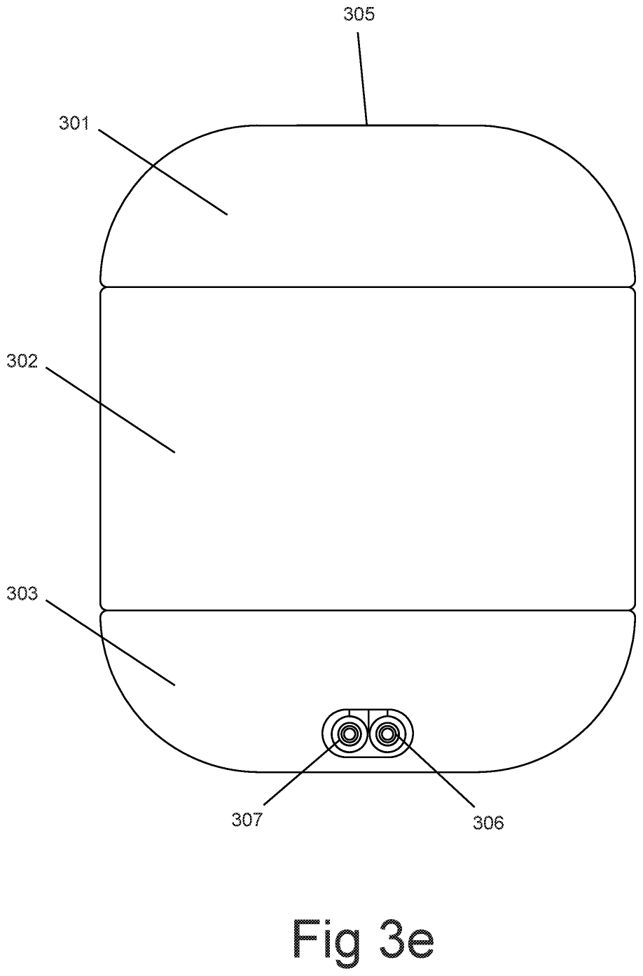

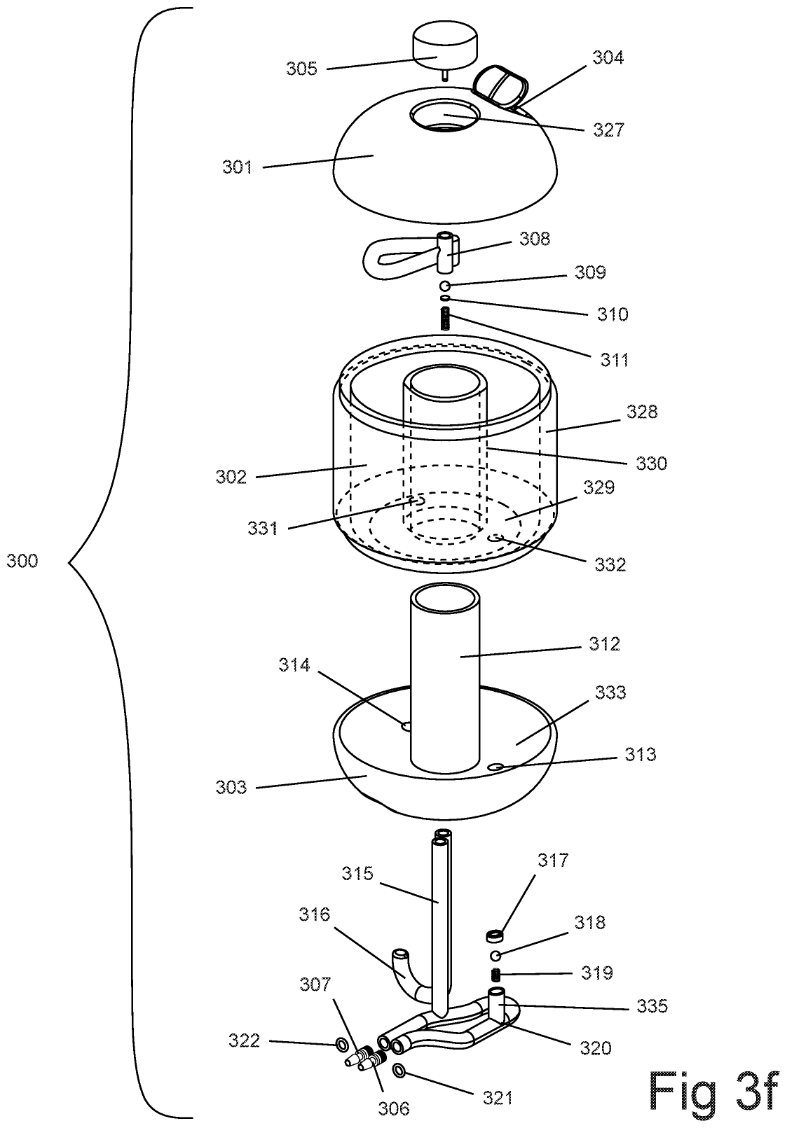

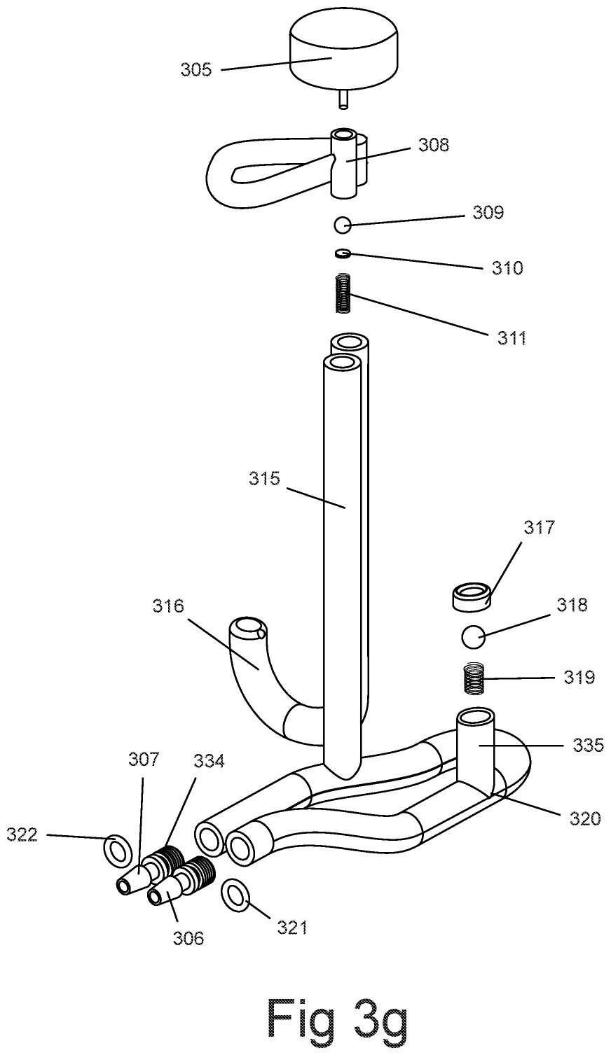

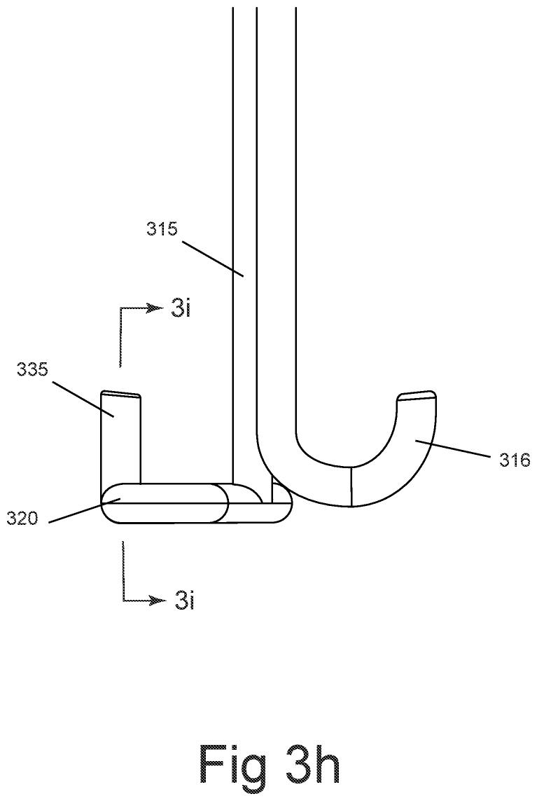

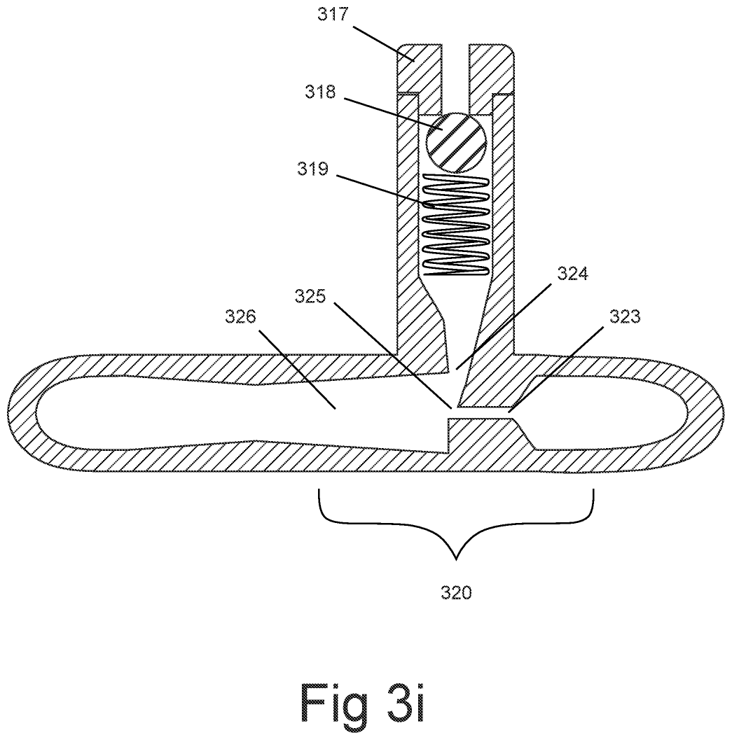

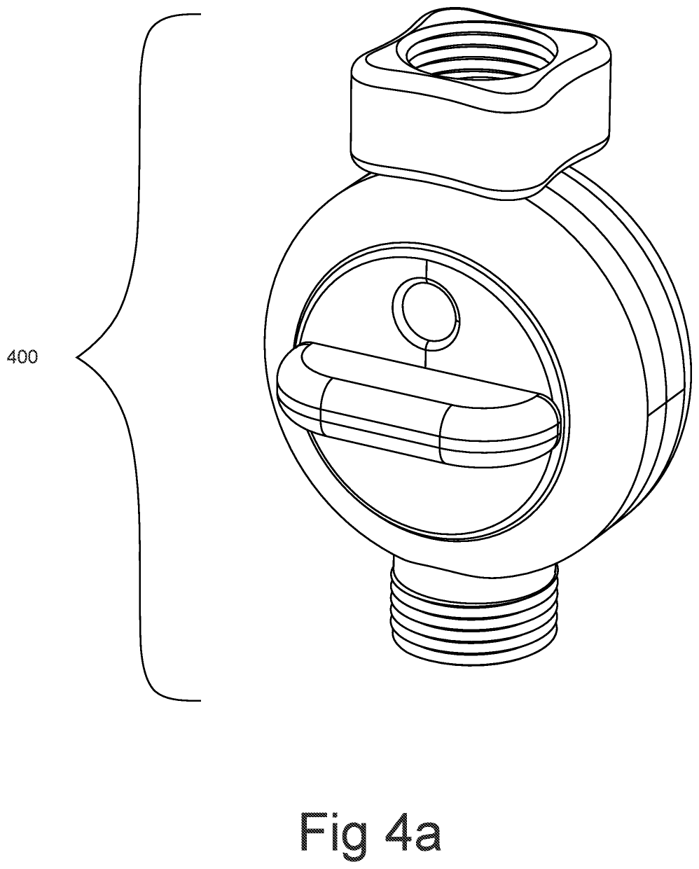

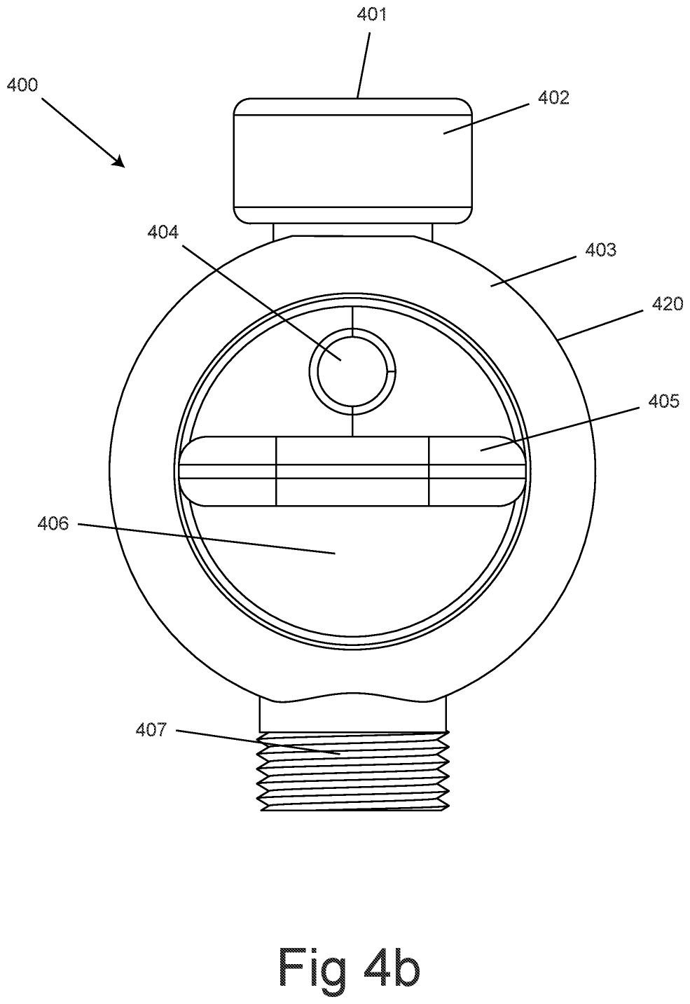

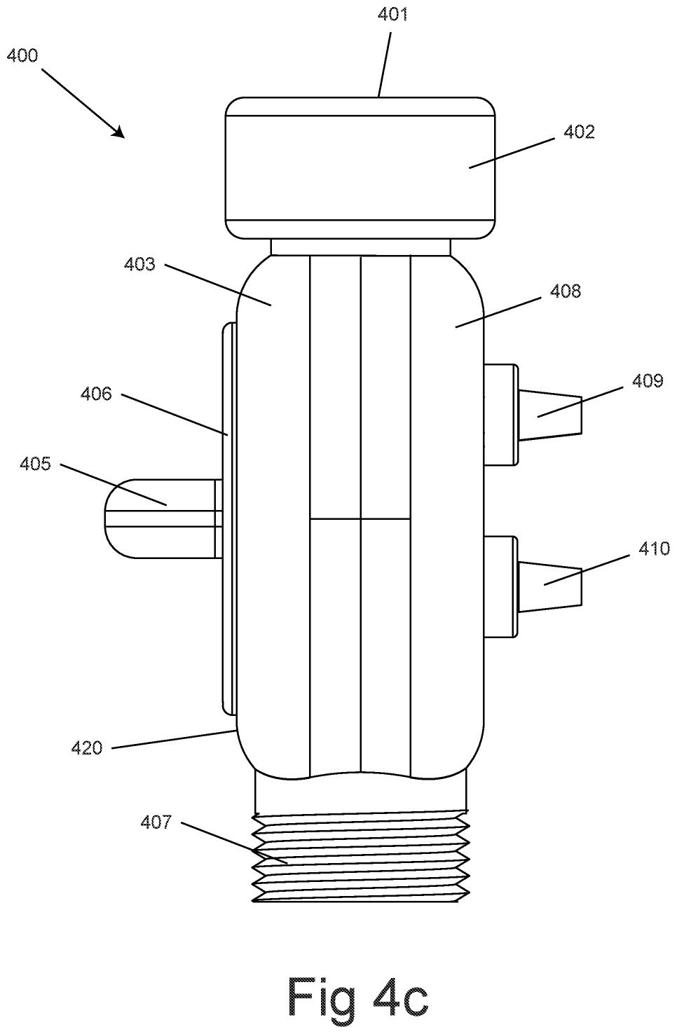

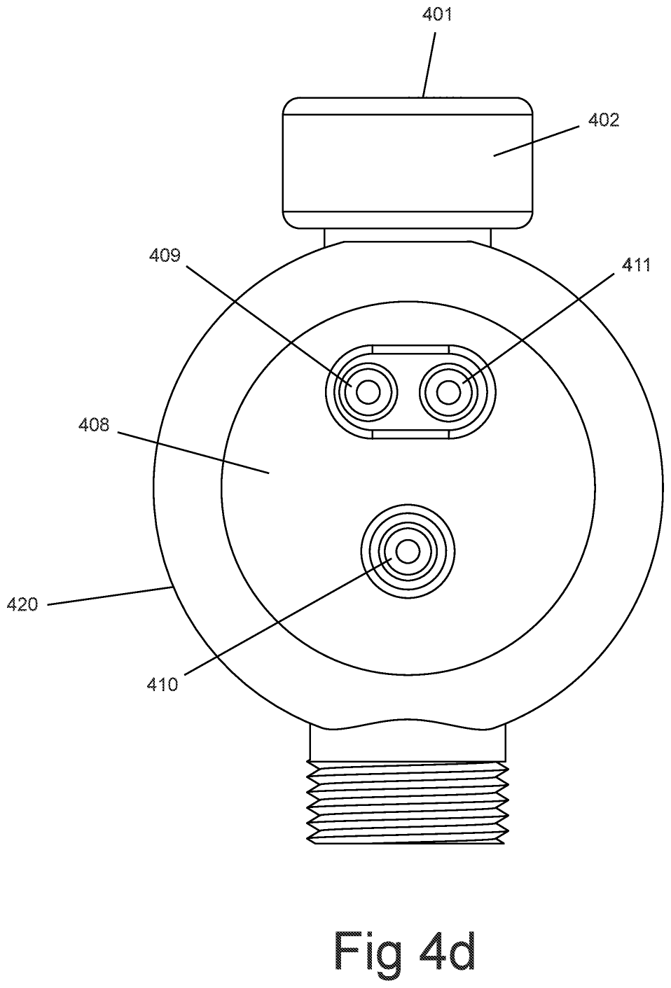

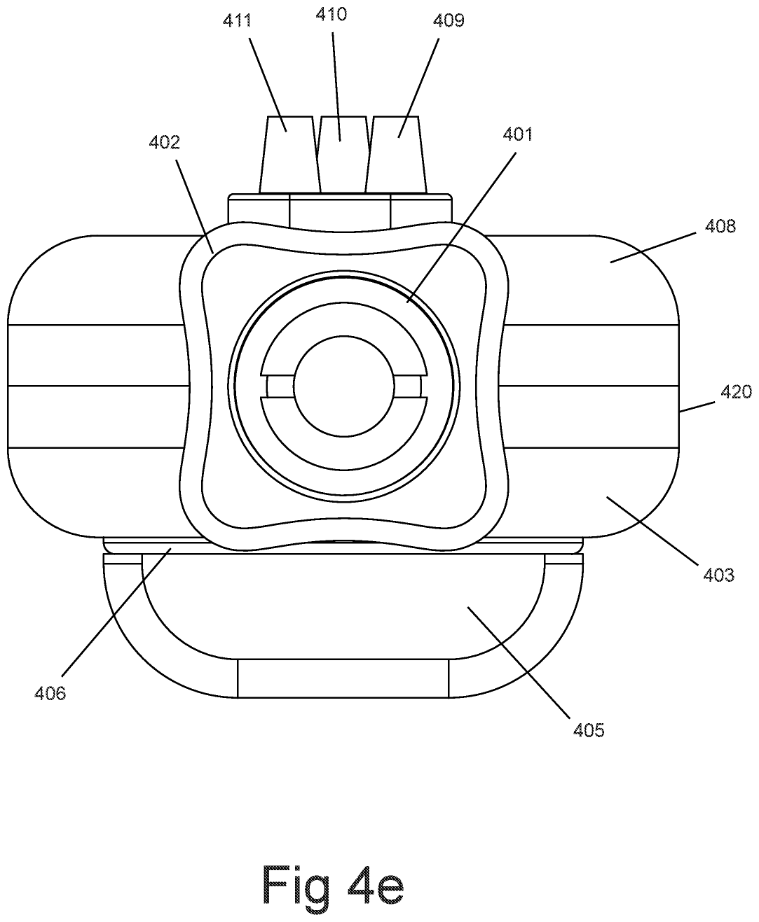

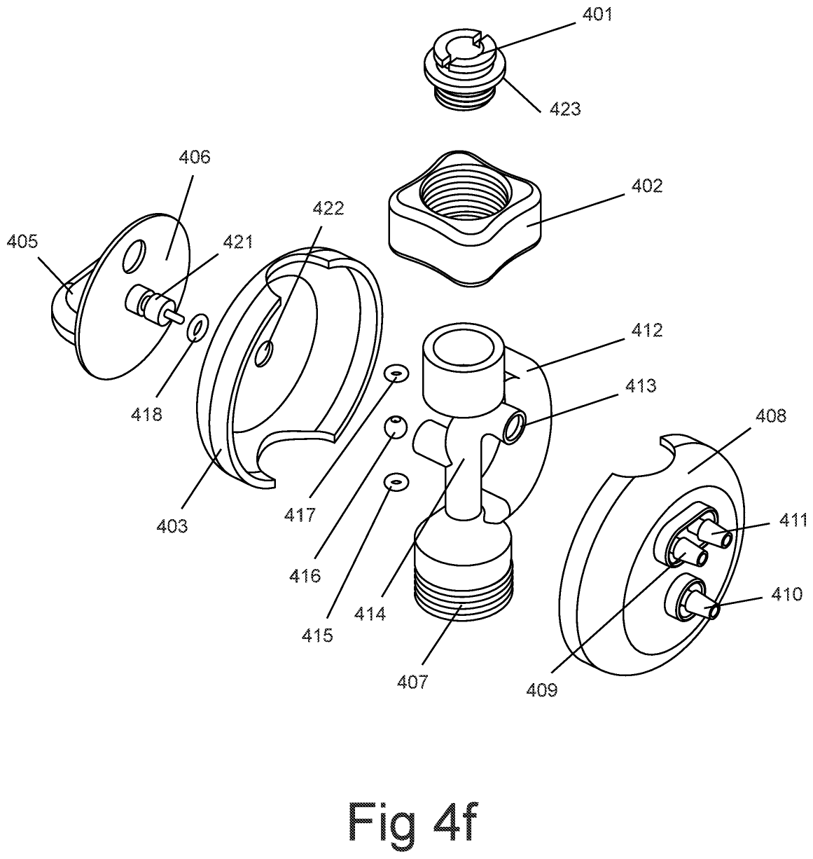

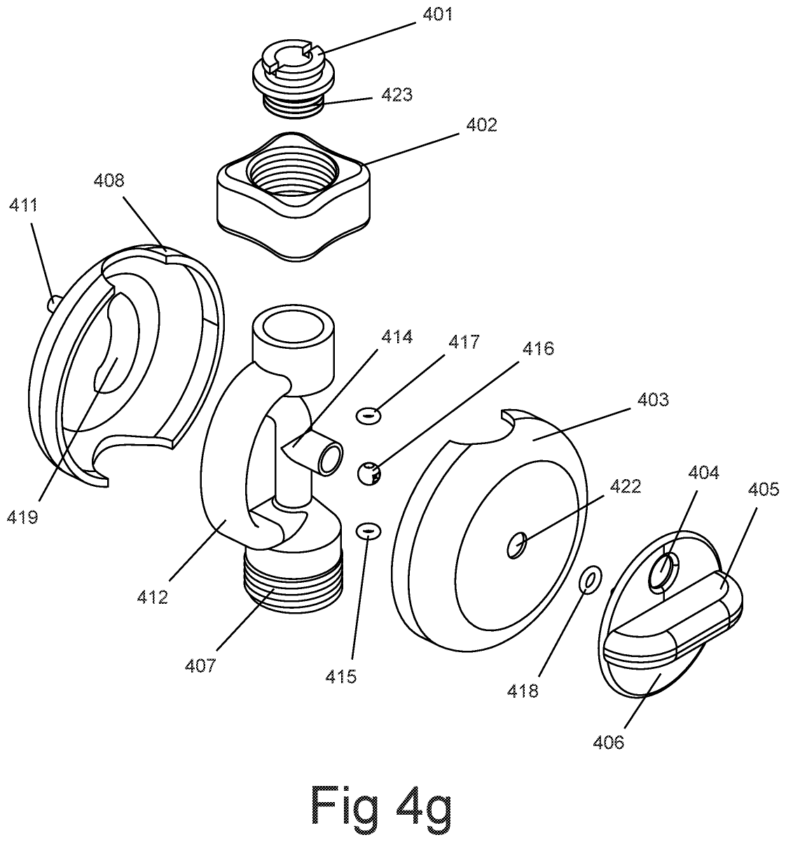

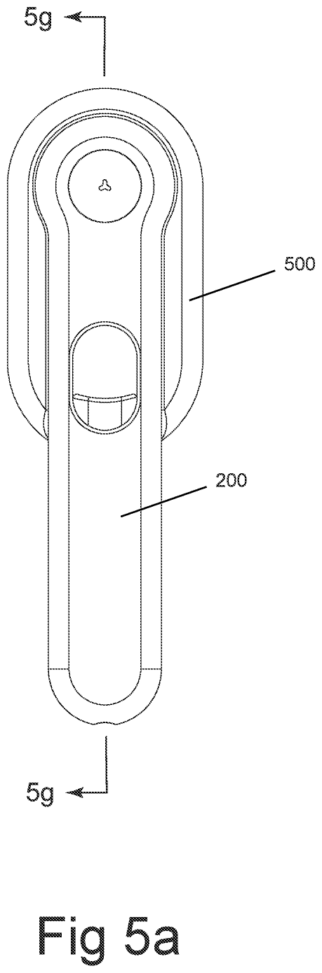

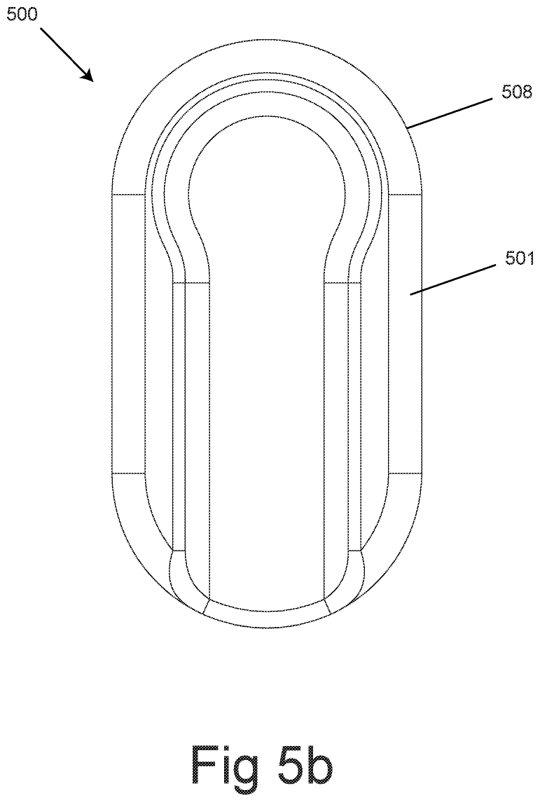

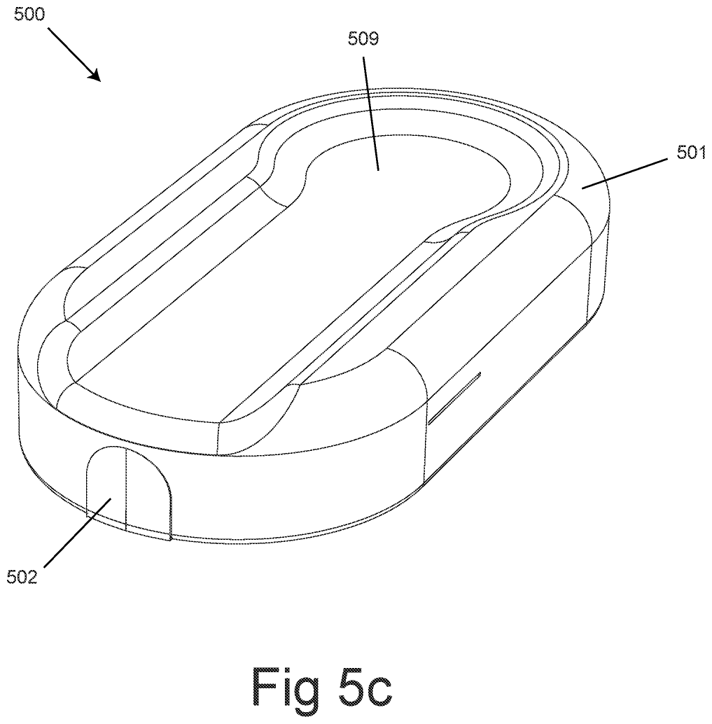

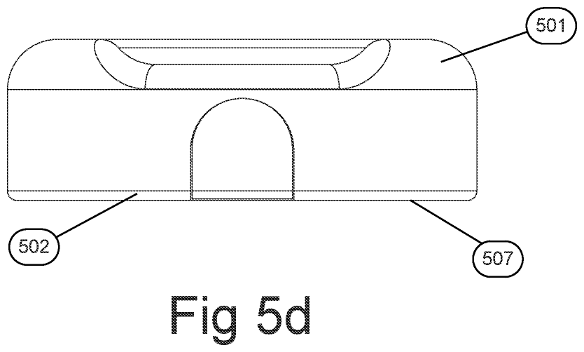

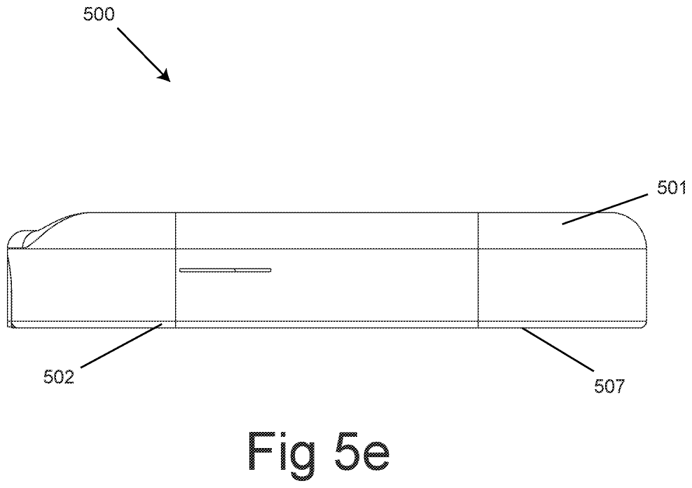

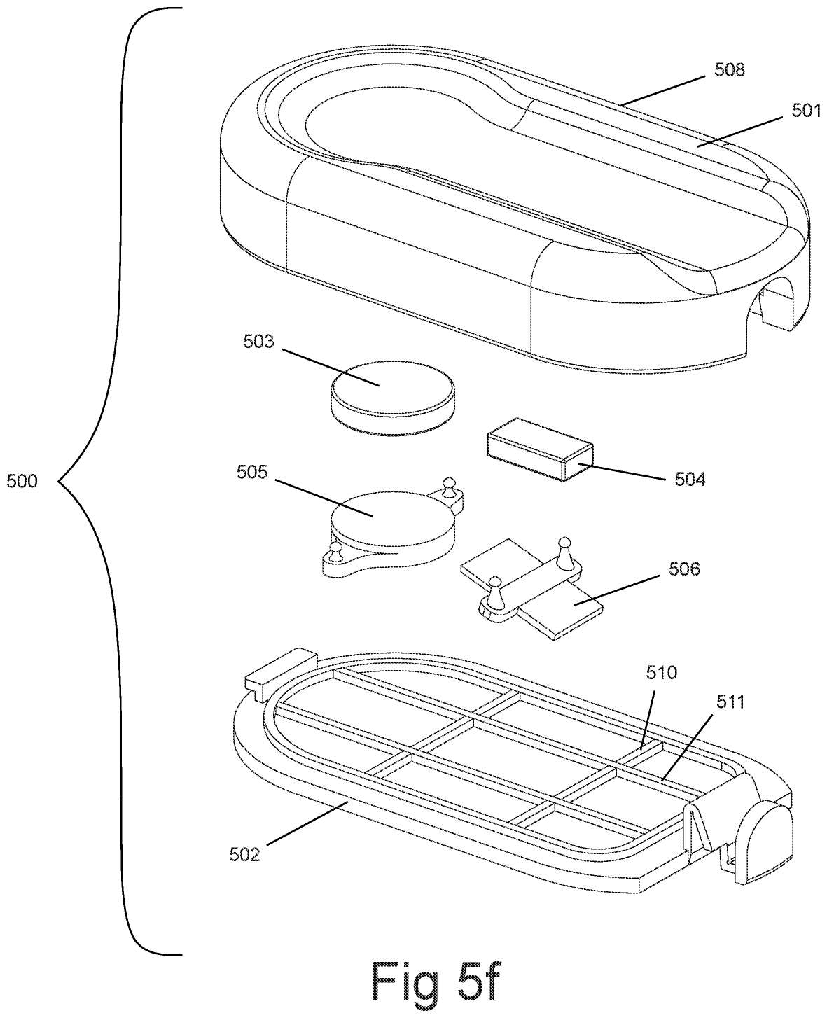

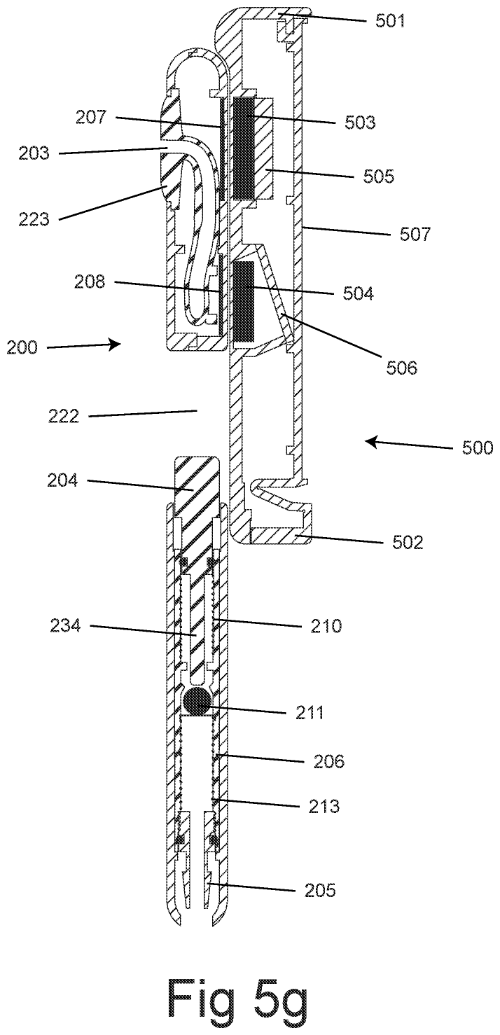

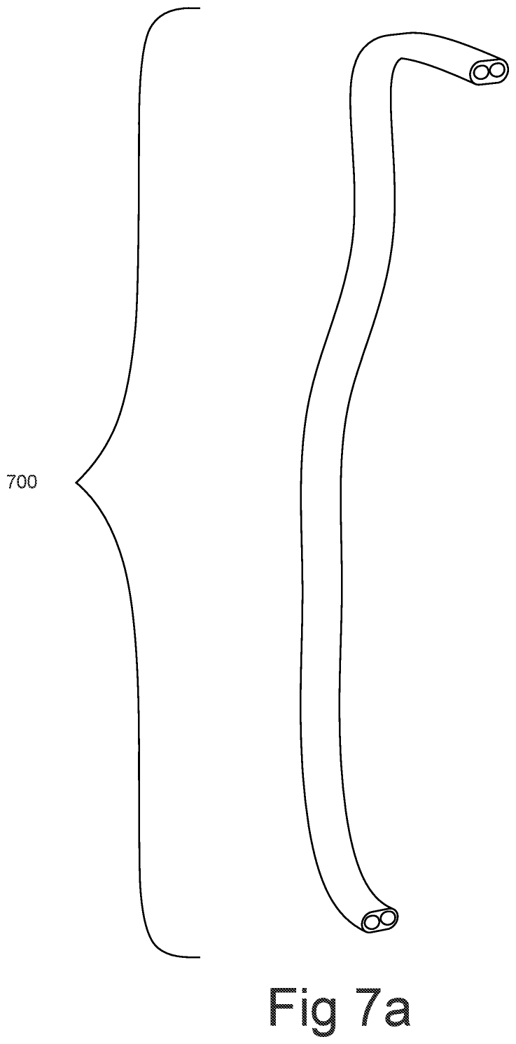

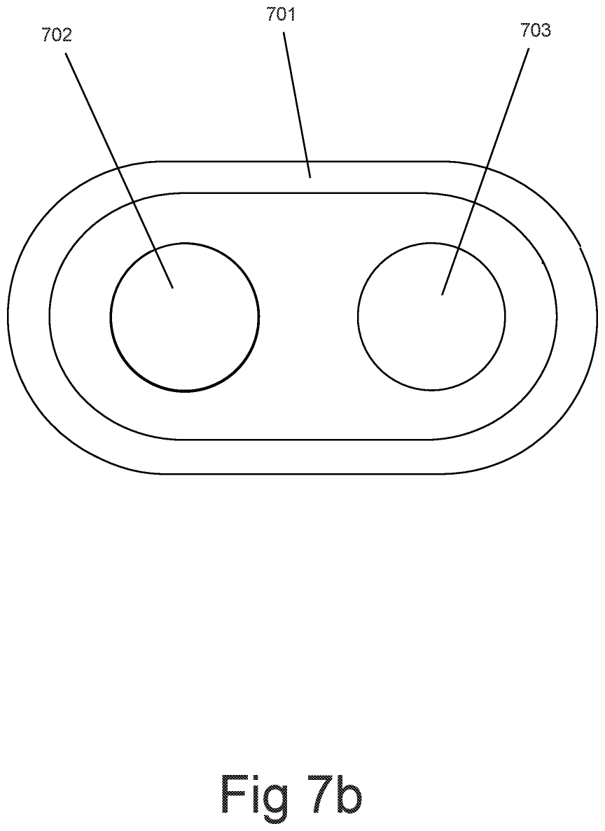

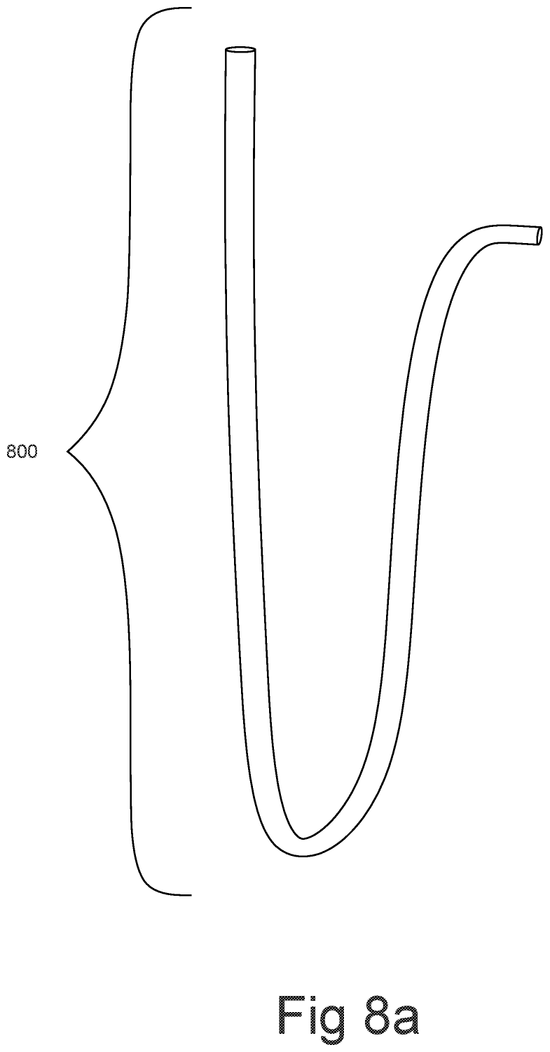

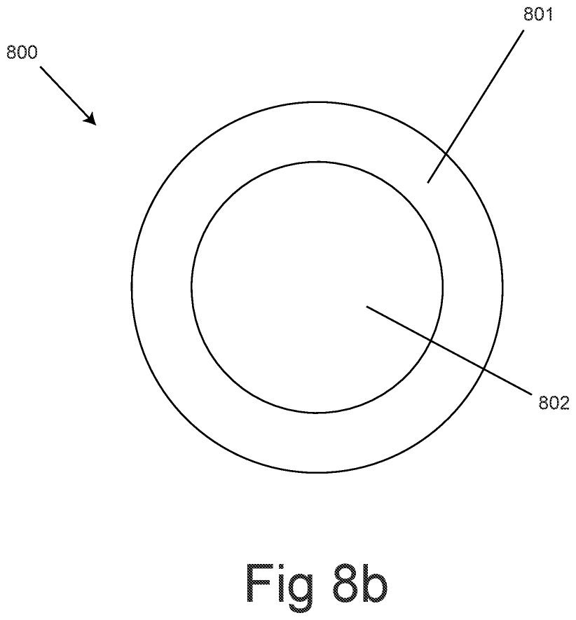

The one or more components of the system 100 is also configurable to include one or more of: a fluid applicator 200, described in more detail in FIGS. 2A-I; an adapter 400, described in more detail in FIGS. 4A-G, a mixing pod 300, described in more detail in FIGS. 3A-I; a docking station 500, described in more detail in FIGS. 5A-G; a unidirectional hose 800 for connecting the fluid applicator 200 to the adapter 400, described in more detail in FIGS. 8A-B; and a bidirectional hose 700 for connecting the adapter 400 to the mixing pod 300, described in more detail in FIGS. 7A-B.

The system 100 can also be incorporated into other plumbing devices including, but not limited to a bidet 130 as shown in FIG. 1B, a toilet seat 140 as shown in FIG. 1C, a bidet adapter 150 as shown in FIG. 1D, and a handheld hose-nozzle 160 configuration as shown in FIG. 1E. Hex head plumbing connectors 120 can be used to provide a threaded connection between components.

The system can be configured to connect directly or indirectly to a plumbing connection that feeds the toilet tank. Alternatively water may be sourced from another water outlet or via a refillable tank.

The mixing pod can be placed on or near, mounted on, attached to or applied to toilet tank inlet or the toilet's surface, hanging from the toilet, near the toilet, or integrated into the toilet or toilet seat itself.

### II. Fluid Applicator

FIG. 2A illustrates a front perspective view of an exemplar fluid applicator 200 of a personal hygiene washing device or system. The fluid applicator 200 has a housing 220. As illustrated, the housing 220 is elongated in a first plane and narrow in a second plane, perpendicular to the first plane. The fluid applicator 200 can have an overall 3-dimensional rectangular shape with curved sides. A slightly wider distal end to provide a keyhole shape in a plane can be used, as illustrated. Other shapes can be utilized without departing from the scope of the disclosure including but not limited to an elongated circular rod, an elongated oval rod, and elongated triangular rod, and an elongated square rod. A proximal housing aperture 232 can be provided for engaging a unidirectional hose. The fluid applicator 200 can have a length of from 150 mm to 300 mm (preferably 218 mm) and a thickness of from 10 mm to 20 mm (preferably 15 mm).

The illustrated form factor provides an ergonomic rounded flat wand design with a flat trigger button that is actuated when the flat trigger button is moved in a proximal direction. The thin design allows for easy insertion between the user's body and, for example, a toilet seat, or between a user's legs.

FIG. 2B is a front planar view of the fluid applicator 200 illustrating a front face of the fluid applicator 200. For purposes of orientation, the fluid applicator 200 has a proximal end 10 and a distal end 20, where the proximal end 10 is closest to a hand of the user and the distal end 20 is farthest away from the hand of the user during use. An aperture with a plurality of concave sides is provided on a face of the fluid applicator 200 at the distal end 20, such as triangular fluid delivery aperture 203. The triangular fluid delivery aperture 203 is in fluid communication with a water source. As illustrated, the triangular fluid delivery aperture 203 has three curved sides, such as a negatively curved triangle with concave sides as illustrated. The three curved sides of the triangular fluid delivery aperture 203 cause the fluid passing through the triangular fluid delivery aperture 203 to achieve a straight or substantially straight fluid stream upon exiting the fluid applicator 200. The straight or substantially straight stream is narrow and consistent and results in a more accurate application of fluid to target anatomy during use and reduces splash from the fluid. As will be appreciated by those skilled in the art, the triangular fluid delivery aperture with concave sides could be a square aperture with concave sides, rectangular aperture with concave sides, octagonal aperture with concave sides, etc. without departing from the scope of the disclosure. Other non-linear side shapes can be used without departing from the scope of the disclosure.

A user controls fluid passing through the fluid applicator 200 to the triangular fluid delivery aperture 203 by use of a fluid controller 204. The fluid controller 204 can be an insert that fits within an interior guide or channel in the housing which is accessible by a control aperture 222. When a user applies pressure in a proximal direction, the fluid controller 204 moves proximally within the channel to allow fluid to reach the triangular fluid delivery aperture 203. In another configuration, the fluid controller 204 can be a button positioned on an exterior surface of the housing that is pressed by the user. The illustrated fluid controller 204 design allows both left handed and right handed users to easily activate the fluid controller 204 from either the front of the body or the back of the body using either their thumb or index finger.

FIG. 2C is a side view of the fluid applicator 200. From the side view, in this configuration the housing 220 has a two piece configuration, such as a front housing piece 201 and a rear housing piece 202. The two piece configuration can also be a distal housing piece and a proximal housing piece. Additionally, a single piece construction can also be achieved for some configurations using, for example, 3-D printing techniques without departing from the scope of the disclosure.

FIG. 2D is an interior view of the fluid applicator 200 and rear housing piece 202 with the front housing piece removed. The distal end 20 of the housing has a triangular fluid delivery aperture face 223 surrounding the triangular fluid delivery aperture 203. The fluid controller 204 engages a valve positioned within a valve housing 206. The valve controls fluid passing into the valve housing 206 via the unidirectional fluid applicator hose connector 205, such as the barb connector illustrated, to the triangular fluid delivery aperture 203 via the fluid applicator internal hose 224. A plurality of female posts 225 can be provided which allow for a snap-fit engagement with a corresponding male post on an interior of the front housing piece. A plurality of ribs 226, 227 can be provided which extend either along a proximal-distal axis or perpendicular to the proximal-distal axis. Other rib configurations and orientations can be used without departing from the scope of the disclosure.

FIG. 2E is an exploded perspective view of the fluid applicator 200 from a front surface. The rear housing piece 202 is shown along with a first fluid applicator magnetic plate 207 and a second fluid applicator magnetic plate 208. The first fluid applicator magnetic plate 207 is configurable to fit within a distal rear housing aperture 228 within the rear housing piece 202. The second fluid applicator magnetic plate 208 is configurable to be spaced apart from the first fluid applicator magnetic plate 207 within an interior cavity of the housing. The triangular fluid delivery aperture face 223 has a plurality of inward facing perpendicular teeth 229 that extend from a surface of the triangular fluid delivery aperture face 223. The fluid controller 204 can include one or more fluid applicator flanges 235 on an exterior surface of the fluid controller 204 that facilitates guiding the fluid controller 204 in a proximal-distal movement during use. The valve housing 206 includes a valve (not shown) within its interior to control fluid movement between the unidirectional fluid applicator hose connector 205 and the fluid applicator internal hose 224. As discussed below, the magnet components are part of a docking system to securely store the fluid applicator 200 during storage.

FIG. 2F is another exploded perspective view of the fluid applicator 200 similar to the exploded view of FIG. 2E. In addition to the components illustrated in FIG. 2E, the fluid controller 204 also includes a first fluid controller O-ring 209, and a trigger spring 210. The valve housing 206 can include a fluid applicator piston valve ball 211, a fluid applicator piston valve pressure plate 212, a fluid applicator piston valve spring 213, and a second fluid controller O-ring 214 in its interior to control fluid communicating from a fluid source to the triangular fluid delivery aperture 203. An exemplar male post 230 on an interior surface of the front housing piece 201 suitable for mating with one of the female posts 225 positioned on the interior surface of the rear housing piece 202 is visible through a front housing distal aperture 231. The front housing distal aperture 231 is operable to receive the triangular fluid delivery aperture face 223.

Turning now to FIG. 2G, is a cross-sectional view of the fluid controller 204 from FIG. 2E. A fluid applicator piston valve ball 211 is positioned between a trigger spring 210 and a fluid applicator piston valve spring 213. The fluid applicator piston valve spring 213 is positioned adjacent a fluid applicator piston valve pressure plate 212 which is positioned adjacent the fluid applicator piston valve ball 211. When the fluid controller interface 233 is moved in a proximal direction the piston 234 moves proximally to move the fluid applicator piston valve ball 211 proximally and open the valve to allow fluid to pass from the unidirectional fluid applicator hose connector 205 to the fluid applicator internal hose 224.

FIG. 211 is a cross-sectional view of a portion of the housing illustrating the triangular fluid delivery aperture 203 within the triangular fluid delivery aperture face 223 in communication with a closed fluid communication channel 236. FIG. 21 is a front view of the triangular fluid delivery aperture face 223 with the triangular fluid delivery aperture 203 wherein the triangular fluid delivery aperture 203 has a plurality of concave sides.

In some configurations, the fluid applicator can also include a dryer, such as a fan, positioned at the distal end for use after application of fluid. The dryer can include a power source, such as a battery or turbine, or be manually powered.

In other configurations, a mechanism for warming the fluid prior to delivery can be provided. In still other configurations, a mechanism for providing a cleansing solution in a first step and a rinsing solution (such as water) in a second step can be provided. In still other configurations, the fluid applicator can be configured to automatically switch between delivery of a first fluid and a second fluid via a separate button or via a timer.

The fluid applicator 200 can be made from any suitable material including, but not limited to plastic or thermoplastic polymer including, for example, polyethylene or polypropylene. Other materials can be used without departing from the scope of the disclosure. Suitable antibacterial coatings or layers can be applied to the exterior surface of the fluid applicator 200 to increase hygiene.

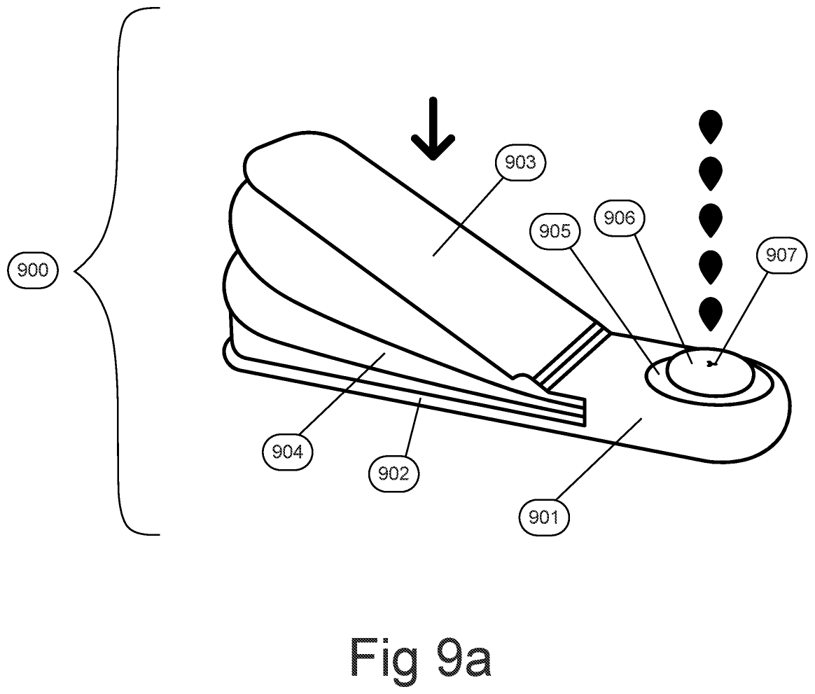

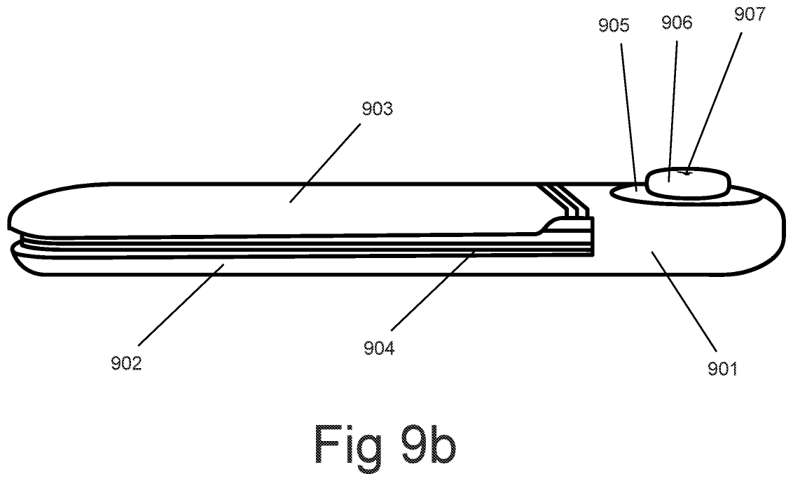

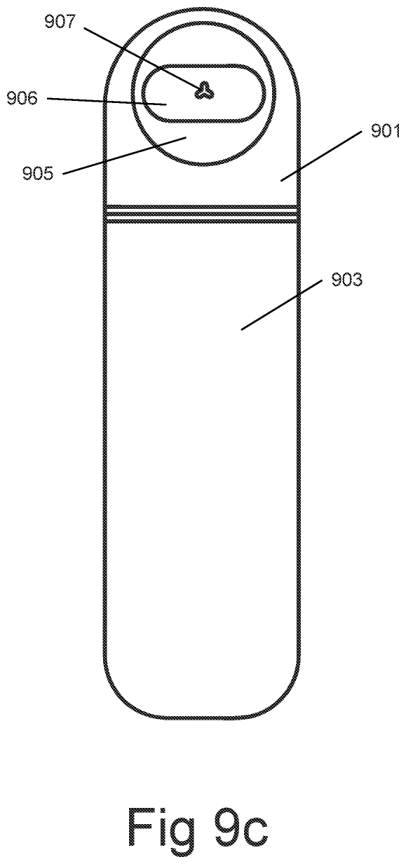

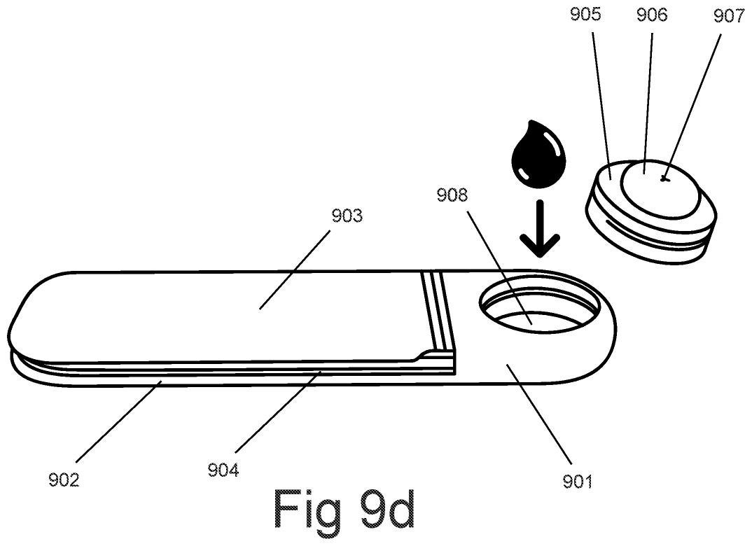

FIGS. 9A-D illustrate a portable fluid applicator 900. The fluid applicator 900 has a housing 920. Distal housing piece 901 and proximal housing pieces 902, 903 are provided. A triangular fluid delivery aperture 907 with a plurality of concave sides, similar to the aperture provided in the embodiment illustrated in FIG. 2, is provided on a face 905 of the portable fluid applicator 900 at the distal end, such as triangular fluid delivery aperture 907. A removable cap 906 is provided to enable a user to add fluid and/or a concentrate to a reservoir 904 or an interior cavity of the portable fluid applicator 900. Any fluid can be added to the reservoir 904 including: water, a cleansing agent, or a concentrate. Additionally, non-liquid concentrates can be added which are dissolved with the addition of a liquid.

The expandable proximal portion of the housing is configurable to hold 200 mL to 400 mL, more preferably 300 mL when fluid is added to the reservoir.

The portable fluid applicator 900 can have a length of from 150 mm to 300 mm (preferably 218 mm) and a thickness of from 10 mm to 20 mm (preferably 15 mm) when it is in a closed or compact condition. When fluid is added to the reservoir, the reservoir 904 expands so that a distance is created between the distal housing piece 901 and the proximal housing pieces 902, 903 along at least a portion of the length of the portable fluid applicator 900. In the embodiment disclosed, the distance created is greatest at the proximal most end of the portable fluid applicator 900 so that the application has a v-shape in a dimension. In use, the user presses the distal housing piece 901 towards the proximal housing pieces 902, 903 to eject the fluid through the triangular fluid delivery aperture 907.

The portable fluid applicator 900 can be made from plastic or thermoplastic polymer including, for example, polyethylene or polypropylene. The reservoir 904 can be made from a suitably flexible material such as polysiloxane and can be configured to present a plurality of folds when the proximal housing pieces 902, 903 are adjacent one another.

### III. Fluid Mixing Pod

FIG. 3A illustrates a fluid mixing pod 300 having an interior mixing chamber. The mixing pod 300 is operable to mix two or more materials. More particularly, the mixing pod is operable to mix two or more materials wherein one material is water and a second material is a cleaning material. Even more particularly, water is mixed with a viscous cleaning solution. The mixing pod 300 can have a round cross-section in one dimension and a height in a second dimension. Other shapes can be used without departing from the scope of the disclosure including, for example, square, rectangular, ovoid, triangular, and hexagonal. The sides of the mixing pod 300 can be curved or angular.

Turning to FIG. 3B, the mixing pod 300 has a mixing pod cap 301, a mixing pod chamber 302, and a mixing pod base 303. The mixing pod 300 and its components can be formed integrally or can be formed from separate components. Suitable materials include plastic or thermoplastic polymer including, for example, polyethylene or polypropylene.

As shown in FIG. 3C, the mixing pod 300 can include a filling controller 305, such as a button. The filling controller 305 can be provided to control fluid movement from outside the mixing pod 300 to an interior chamber of the mixing pod. An insertion hatch 304 can be provided which includes a mechanism to deliver a concentrate for dilution into the interior chamber of the mixing pod 300. As illustrated in FIG. 3C these components can be provided on an upper surface of the mixing pod. However, the components can be positioned on other surfaces without departing from the scope of the disclosure.

The insertion hatch 304 can be any suitable opening. That opening may close through a retractable or slidable door or hatch, a screwcap or lid, or other mechanisms. In lieu of an insertion hatch, an attachable pod, capsule or tubing can be provided for delivering a material to the interior of the chamber. The material can be a fluid or a solid, and can be ready for application or diluted with the addition of water.

In still other configurations, a mechanism for providing a cleansing solution to the fluid applicator in a first step and a rinsing solution to the fluid applicator (such as water) in a second step can be provided. In still other configurations, the mixing pod 300 can be operable to automatically switch between two fluid solutions via an actuator or a timer.

FIG. 3D is a first side view of the mixing pod 300. In addition to the mixing pod cap 301, mixing pod chamber 302, and mixing pod base 303, a mixing pod outlet connector 306, such as a barb hose connector, is illustrated. FIG. 3E is another side view rotated 90° from the view in FIG. 3D. From this view, it can be appreciated that the mixing pod 300 has a mixing pod outlet connector 306 and a mixing pod inlet connector 307. The mixing pod outlet connector 306 and mixing pod inlet connector 307 can be positioned adjacent one another, as illustrated, or at different locations without departing from the scope of the disclosure. For example, an inlet can provide fluid to the mixing pod 300 from an upper surface, or an upper side surface while the outlet removes fluid from a lower surface or below the mixing pod 300.

FIG. 3F is an exploded view of the mixing pod 300. In this view, the mixing pod cap 301 has a mixing pod cap aperture 327 which receives the filling controller 305. The filling controller 305 moves within the mixing pod cap aperture 327 to engage a mixing chamber filling piston valve casing 308. The mixing chamber filling piston valve casing 308 has an aperture that is configured to receive a mixing chamber filling piston valve ball 309, a mixing chamber filling piston valve plate 310 and a mixing chamber filling piston valve spring 311. When the mixing pod 300 is tubular or substantially tubular, the mixing chamber 302 has an outer chamber wall 328, a bottom chamber wall 329, and a center chamber wall 330. The center chamber wall 330 defines a tubular opening in communication with the filling controller 305 and mixing chamber valve tubing 315. The bottom chamber wall 329 can further include a chamber inlet aperture 331 and a chamber outlet aperture 332. The mixing pod base 303, has a mixing pod column 312, illustrated as a tubular column, which extends from an upper base interior surface 333 of the mixing pod base 303. The mixing pod column 312 nests within the center chamber wall 330 of the pod chamber 302. A mixing chamber outlet aperture 313 and a mixing chamber inlet aperture 314 pass through the mixing pod base 303. The mixing chamber outlet aperture 313 and a mixing chamber inlet aperture 314 are positioned to correspond to the chamber outlet aperture 332, and the chamber inlet aperture 331 of the mixing pod chamber 302, respectively. The mixing chamber outlet aperture 313 and a mixing chamber inlet aperture 314 can be positioned on opposing sides of the mixing pod column 312 as illustrated or in other locations without departing from the scope of the disclosure. As illustrated, tubing is provided for the mixing chamber valve tubing 315 and mixing chamber inlet tubing 316 for the mixing chamber filling inlet is provided. A venturi injector 320 can also be provided in communication with the tubing to the mixing chamber valve tubing 315, and the mixing pod inlet connector 307. The mixing pod outlet connector 306 and the mixing pod inlet connector 307 each have an O-ring, pod outlet O-ring 321 and pod inlet O-ring 322, which facilitates engagement with the adjacent tubing.

There may also be an additional valve mechanism to prevent overflow of the filling chamber if, for example, a user presses the filling controller 305 for too long. Additional an filling feedback indicator, such as sound or light, can be provided to alert a user that the mixing pod is full or is approaching fullness. In still another configuration, a user may press the filling controller 305 once and then a timer or volume indicator is provided to automatically stop the addition of fluid to the chamber.

FIG. 3G is a close-up view of the internal components of the mixing pod 300 shown in FIG. 3F from the filling controller 305 to the mixing pod outlet connector 306 and the mixing pod inlet connector 307. As will be appreciated from this view, the mixing pod outlet connector 306 and the mixing pod inlet connector 307 can be provided with threads 334 or ridges, such as rubber ridges, to facilitate a secure connection to the respective inlet or outlet piping. FIG. 3H is a side view of the mixing chamber inlet tubing 316 and mixing chamber valve tubing 315 operable to mixing chamber filling. From this view, the mixing chamber valve tubing 315 has a bend towards a venturi injector 320 in communication with a tubing extension 335 which engages tubing from the mixing chamber outlet 317 and the venturi injector valve ball 318 and venturi injector valve spring 319. FIG. 3I is a cross section of the venturi injector 320. The venturi injector 320 has a venturi injector outlet 326 in communication with a venturi injector nozzle 325. A venturi injector pressure inlet 323 is provided on an opposing side to the venturi injector nozzle 325. A venturi injector vacuum inlet 324 is positioned adjacent and perpendicular to the venturi injector nozzle 325. The venturi vacuum inlet 324 has a venturi injector valve spring 319 and a venturi injector valve ball 318 adjacent tubing from the mixing chamber outlet 317.

The mixing pod 300 can be made from any suitable material including, but not limited to plastic or thermoplastic polymer including, for example, polyethylene or polypropylene. In one configuration, the mixing pod chamber 302 is made from a transparent or translucent material, or is configured to include a transparent or translucent insert. Additionally, a fluid level indicator can be provided, such as along an exterior surface. The mixing pod 300 can be formed from a plurality of parts or formed integrally.

### IV. Adapter

FIG. 4A is a perspective front view of an adapter 400. The adapter 400 is positionable between the supply line and the mixing pod. As shown in FIG. 4B, a planar front view of the adapter 400, a female adapter attachment 401 is provided to engage a toilet tank (shown in FIG. 1A). The female adapter attachment 401 features an inlet screw knob 402 which enables the female adapter attachment 401 to engage the toilet tank. A front surface 403 of the adapter housing 420, has a valve state indicator 404 and an adapter valve controller 405 for changing a valve state from opened to closed, and vice versa. A valve dial plate 406 can be provided. A male adapter attachment 407 is provided to engage a supply line (shown in FIG. 1A). FIG. 4C is a side view of an adapter 400 which also shows a rear surface 408 of the adapter housing 420. An adapter inlet connector 409, such as the barb hose inlet connector illustrated, and an adapter outlet connector 410, such as the barb hose outlet connector illustrated, can be provided. The adapter inlet connector 409 is in fluid communication with the mixing pod of FIG. 3 and the adapter outlet connector 410 is in communication with the fluid applicator of FIG. 2. FIG. 4D is a planar view of the back surface of the adapter 400. From this view, it will be appreciated that adapter inlet connector 409 is adjacent a mixing pod outlet connector 411. Turning now to FIG. 4E, a top view of an exemplar adapter 400 is illustrated.

FIG. 4F is an exploded view of the adapter 400 from a back surface perspective and FIG. 4G is an exploded view of the adapter 400 from a front surface perspective. The adapter valve controller 405 can be a knob positioned on an exterior facing surface of a valve dial plate 406. An interior surface of the valve dial plate has a shaft 421 that extends perpendicularly from the interior surface and engages a valve controller O-ring 418. The shaft passes through a front housing aperture 422 in the front surface 403 of the adapter housing to engage a valve casing 414. The female adapter attachment 401 is a threaded tube with a flange 423 positioned along its length and operable to engage a toilet tank inlet. The height of the threads along the tube is less than the height of the flange 423 extending from the threaded tube. The toilet tank inlet attachment 401 threads into an interiorly threaded aperture of the inlet screw knob 402. The male adapter attachment 407 provided to engage the supply line connects to a valve casing 414, a transfer tube 412, and a mixing pod connector tube 413. A adapter valve inlet O-ring 415, valve ball 416, and an adapter valve outlet O-ring 417 are provided within the interior of the valve casing 414. The rear surface 408 of the adapter housing has an adapter inlet connector 409, a mixing pod outlet 411, and an adapter fluid applicator outlet 410.

### V. Docking Station

FIG. 5A illustrates a front view of a docking station 500 engaging a fluid applicator 200. FIG. 5B is a front view of the docking station 500. The docking station 500 has a docking station housing 508 which can include a front docking station housing casing 501. As illustrated, the docking station 500 can have an oval shape in a first plane. FIG. 5C is a perspective view of the docking station 500 which illustrates a docking station external recess 509 which is sized to fit the fluid applicator. The docking station external recess 509 can provide walls on three sides of the docking station external recess 509 to allow the fluid applicator to extend beyond the length of the docking station 500 on one side. From the side view shown in FIG. 5D the front docking station housing casing 501 can engage a rear docking station housing casing 502. The rear surface of the docking station has a securement interface. The securement interface can, for example, be an adhesive layer 507 to allow the docking station 500 to be adhered to a surface, such as a wall, or toilet tank, via the adhesive layer 507. Suitable adhesives include, permanent and non-permanent adhesives. Other securement mechanisms, such a fastener receiving aperture, etc., can be employed without departing from the scope of the disclosure. Still other mechanisms may be provided to secure the docking station to a surface including, but not limited to, a suction cup, screws, and a hook. The docking station can be adhered to any suitable surface or device.

FIG. 5E is a side view of the docking station 500. FIG. 5F is an exploded view of the docking station 500. The docking station housing 508 defines an interior cavity which houses a first docking station magnet 503 and a second docking station magnet 504. A first docking station magnet snap case 505 is provided along with a second magnet drum housing 506. The rear docking station housing casing 502 can be provided with a series of structural docking station ribs 510, 511 in a first orientation and docking station ribs in a second orientation. Other rib configurations and orientations can be used without departing from the scope of the disclosure.

FIG. 5G is a cross-sectional view taken along the lines 5G-5G in FIG. 5A. The docking station 500 is shown engaging the fluid applicator 200. As will be appreciated from this view, the first fluid applicator magnetic plate 207 associated with the fluid applicator 200 housing is adjacent the first docking station magnet 503 associated with the docking station 500 when the fluid applicator 200 is docked in the docking station 500. The second fluid applicator magnetic plate 208 associated with the fluid applicator 200 is adjacent the second docking station magnet 504 associated with the docking station 500. The remaining components are described above in FIG. 2G and FIG. 5F. Other mechanism for securing the docking station to a surface can be used without departing from the scope of the disclosure including, but not limited to, hooks, suction cups, two-sided tape, etc.

### VI. Finger Wrench

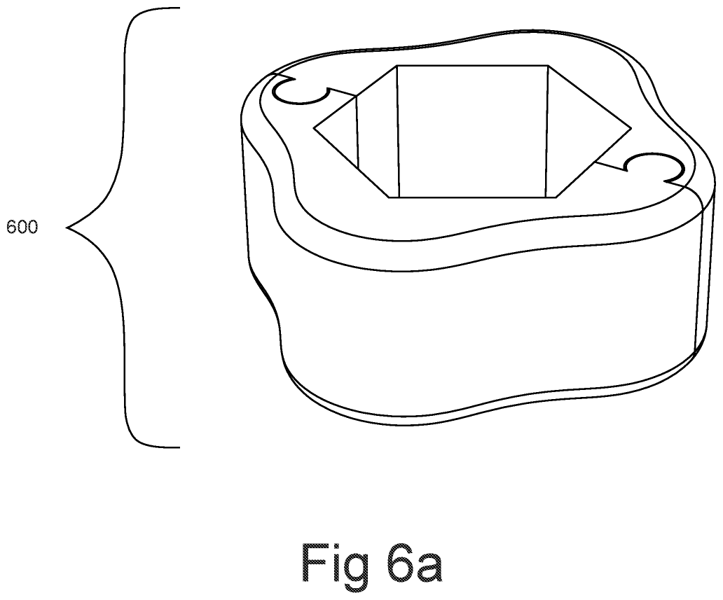

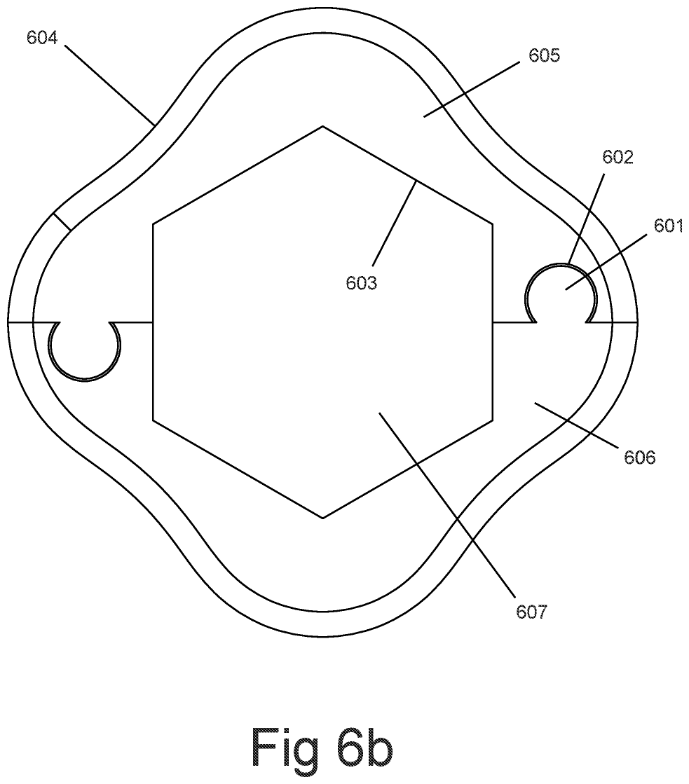

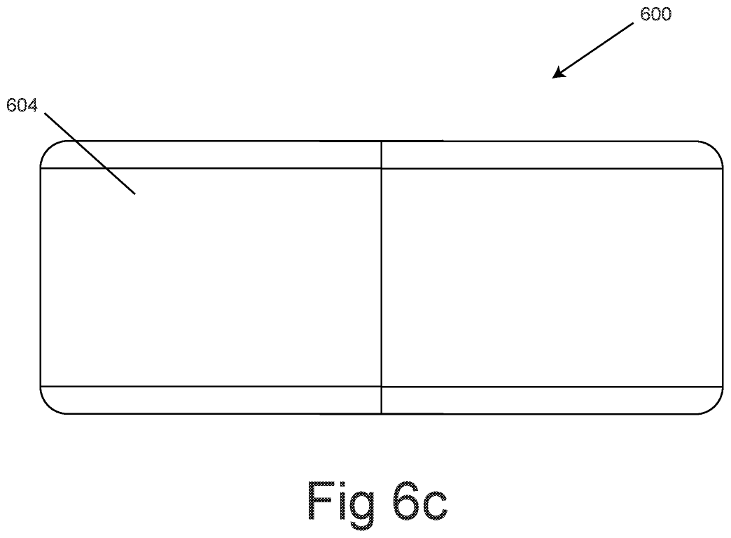

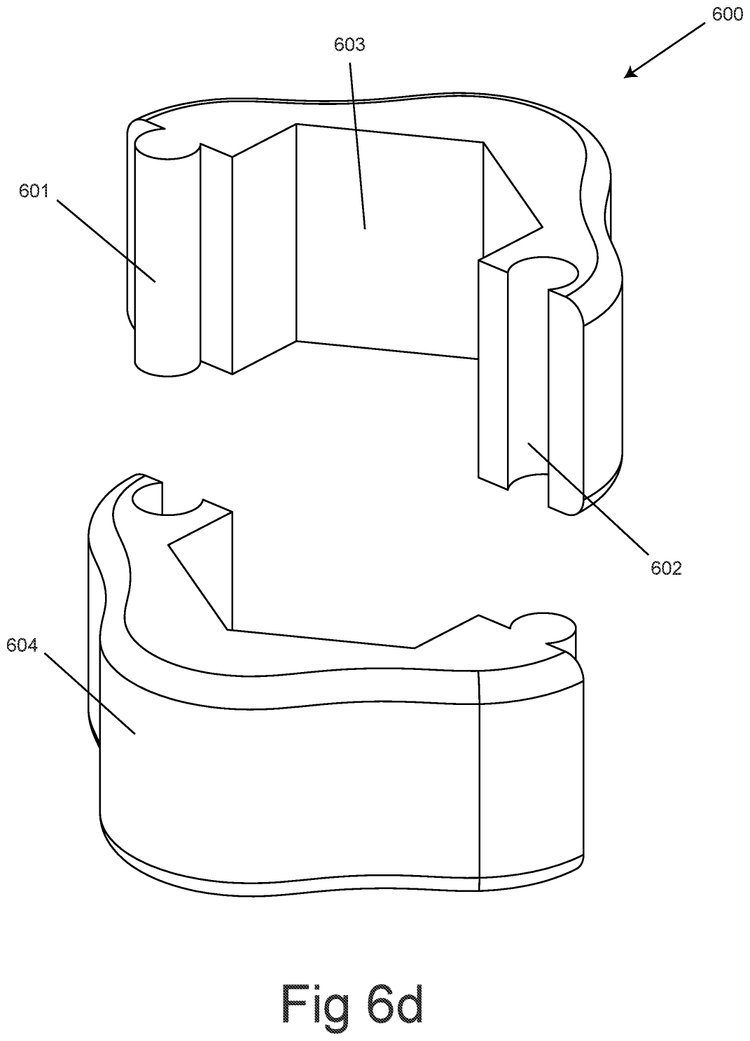

FIGS. 6A-D illustrate a finger wrench 600 for use in installing a personal hygiene washing device and system as disclosed above. The finger wrench 600 has a first component 605 and a second component 606 that releasably engage to form the finger wrench 600. The first and second component can engage using a snap joint. The snap joint can have a convex joint surface 601 associated with, for example, the first component 605 and a concave snap joint surface 602 with, for example, the second component 606. When the first component 605 engages the second component 606 a finger wrench aperture 607 is defined which has a plurality of interior surfaces 603 configured to securely engage an exterior surface of a connector, such as a plurality of flat surfaces configured to securely engage a hex head plumbing connector, such as hex head plumbing connector 120 in FIG. 1A. The finger wrench exterior surface 604 is curved to allow a user to easily grasp the finger wrench during the installation process. FIG. 6C is a side view of the finger wrench 600 showing the finger wrench exterior surface 604. FIG. 6D is an exploded perspective view of the finger wrench 600 device shown in FIGS. 6A-C.

The finger wrench 600 can be formed from multiple pieces of plastic or other suitable material that snap together around a toilet tank water supply, screw knob or bolt to allow a user to easily screw or unscrew the water supply hose to a toilet during installation or removal. The finger wrench 600 may use snap joints to connect the pieces and form a disc around bolt or knob, or they may be held together around the bolt or knob using pressure from the hand. Pieces of the finger wrench 600 may be joined with each other by a thin strip of material. The finger wrench 600 components may disconnect by sliding apart longitudinally. The interior of the pieces may be shaped to assist in gripping a bolt or knob. Additionally, the exterior of the finger wrench 600 components may be covered with embossed or debossed texture, shapes or materials to provide additional gripability during use.

### VII. Bidirectional Carrier

FIGS. 7A-B illustrates a bidirectional hose 700 or pipe or tube suitable for connecting a mixing pod and a connector. FIG. 7B illustrates a side view of the bidirectional hose 700 having an outer sheath 701 defining a first hose aperture 702 and a second hose aperture 703 for connection to the mixing pod outlet connector 306 and mixing pod inlet connector 307 of FIG. 3E at one end and the adapter inlet connector 409 and the adapter outlet connector 411 of the adapter 400 shown in FIG. 4D at a second end.

### VIII. Unidirectional Carrier

FIGS. 8A-B illustrates a unidirectional hose 800 or pipe or tube for connecting a fluid applicator, such as fluid applicator 200 in FIG. 2A to a connector, such as mixing pod outlet connector 306 in FIG. 3A. As shown in the cross-section shown in FIG. 8B, the unidirectional hose 800 has an outer sheath 801 which has an aperture 802 therethrough.

### IX. Concentrate

A concentrate can be used as part of the disclosed personal hygiene washing system. The concentrate may have one or more of, for example cleaning, antibacterial, fragrant, medicinal, pharmaceutical and therapeutic properties. The concentrate can, for example, be in a liquid form, crystalline form, granules form, powder form, tablet form. The concentrate can further be provided in a capsule or a dissolvable casing, e.g., a capsule containing liquid, crystals, granules, powder or tablets. In some configurations, the capsule or dissolvable casing can provide one or more compartments to maintain ingredients separate until the final mixing step.

The user of a concentrate with a fragrance has the benefit of leaving the user with a pleasing scent after using the device and also providing a fragrance into the room . Providing a fragrance into the room during use also acts as a room deodorizer.

The concentrate may contain a surfactant or cleaning agent, for instance a nonionic surfactant such as a sorbitan oleate decylglucoside crosspolymer. Prebiotics can include galactooligosaccharides, fructooligosaccharides, Konjac glucomannan hydrolysate and others to promote growth of lactobacillus acidophilus in the perineum, anus and vagina. Postbiotics can include lactic acid which is a natural antibacterial for the perineum, anus and vagina.

An example of a concentrate is a liquid containing one or more of a no-rinse surfactant, a scrubbing agent and emollient, a prebiotic (e.g., for vaginal health), a postbiotic, and/or antibacterial. The scrubbing agent and emollient can be a hydrolyzed protein such as oats. The prebiotic can be an oligosaccharide (e.g. derived from beans or chicory). The postbiotic, and/or antibacterial can be a lactic acid (e.g., derived from cultured beet sugar). The concentrate can be formulated to be soap free, i.e. free from compounds having a general formula (RCO⁻)ₙMⁿ⁺ (Where R is an alkyl, M is a metal and n is the charge of the cation). The concentrate can also be formulated to provide zero residue and rise off without requiring an additional manual drying step.

The fluid can be pre-diluted or a concentrate ready for dilution. Additionally, the concentrate can be formulated for single use or for application over a plurality of uses.

### X. Methods Of Installation

An installation kit can be provided. During installation, the user can perform one or more of the following steps:

Turn off the shut-off valve 118;

Empty the toilet tank by activating the toilet flush;

Disconnect the existing water supply line 116 between the shut-off valve 118 and the toilet tank 114 fingers, hand, finger wrench 600 or other tools;

Connect the adapter 400 between the water supply line 116 and the toilet tank 114 using fingers, hand, finger wrench 600 or other tools to engage the hex head plumbing connector(s) 120;

Secure the docking station 500 to a surface;

If not already connected, connect the unidirectional hose 800 to a proximal end of the fluid applicator 200 at one end and an adapter 400 at a second end;

If not already connected, connect the bidirectional hose 700 to the mixing pod 300 at a first end and to the adapter 400 at a second end;

Position the mixing pod 300 near the adapter 400; the mixing pod can be secured to a surface or placed on a surface; and

Turn on the shut-off valve 118.

### XI. Method of Use

### A. Filling the Mixing Pod

The user adds the concentrate to the mixing pod 300 via, the insertion hatch 304;

The valve state of the adapter 400 valve can be changed using the adapter valve controller 405 to permit water to be directed from the toilet tank 114 to the adapter 400; and

The filling controller 305 of the mixing pod 300 is activated to allow water to fill the mixing pod 300.

The filling process can be automatic or semi-automatic once activated by the user. When the filling process is automatic, the mixing pod 300 is filled which allows the fluid to come to and be maintained at room temperature in between uses. If the user refills the mixing pod 300 after use, the same result with respect to fluid temperature can be achieved. Allowing the fluid to be maintained in the mixing pod 300 at room temperature can be beneficial where the system is installed in a cold climate where water temperature from an inlet may be colder than comfortable for the user.

In one method, the user can activate the filling controller 305 by pressing a button and holding the button until the user achieves visual confirmation that the mixing pod 300 is full. In another method, activation of the filling controller 305 can cause a predetermined amount of fluid to enter the mixing pod 300. In another configuration, water is added via a refillable tank.

### B. Dilution Methods

The system is configurable to pre-mix water with a concentrate within a mixing chamber before integration with a water flow source for applying the liquid onto the body.

As described above, the mixing mechanism may have a button, lever, valve or other mechanism that allows the user to fill the mixing chamber with water from any suitable water supply. An auto-stop mechanism may be implemented to prevent overflow of mixing chamber with water or liquid. Alternatively, the mixing mechanism may have a hatch or other opening that allows user to fill the mixing chamber with water or other liquid.

The mixing chamber may also include an agitator, a UV applicator, or other mechanism to facilitate the mixing and/or sterilizing the concentrate and the water. Mechanisms may be powered by the movement of water through the system (such as water turning a turbine), an external power source, or other mechanical forces.

Concentrate or a pre-mixed solution can be mixed with water flow for spraying on the body, using a venturi, diversion, or other mixing mechanism.

### C. Device Usage

A user positions the fluid applicator 200 so the triangular fluid delivery aperture 203 is directed toward a target area of interest;

The user activates the fluid applicator 200 by engaging the fluid controller 204. Activation of the fluid controller 204 can be achieved by, for example, pressing a button or using a digit to move a button in a proximal direction within an aperture in the fluid applicator 200;

Fluid passes from the mixing pod 300 and/or the water supply line 116 via the fluid applicator 200 to the target area of interest to apply a fluid in a substantially straight stream with reduced splash; and

The user moves the fluid applicator 200 to other areas of interest as needed.

If the user incorporates the use of the no-rinse nonionic surfactant, no further steps may be required to achieve a dry surface finish. If water is used, then an additional drying step may be taken either via the device or with the use of a secondary material.

In some configurations, water can be applied to the user in a second step.

In some configurations, the fluid may be warmed prior to application for additional comfort of the user in a cold climate.

### XII. Kits

The disclosed personal hygiene washing system can be provided as a kit. The can include one or more of: a fluid applicator 200, described in more detail in FIGS. 2A-I above; an adapter 400, described in more detail in FIGS. 4A-G above, a mixing pod 300, described in more detail in FIGS. 3A-I above; a docking station 500, described in more detail in FIGS. 5A-G above; a finger wrench 600, described in more detail in FIGS. 6A-D above; a unidirectional hose 800 for connecting the fluid applicator 200 to the adapter 400, described in more detail in FIGS. 8A-B above; a bidirectional hose 700 for connecting the adapter 400 to the mixing pod 300, described in more detail in FIGS. 7A-B above; and/or concentrate as discussed in Section IX above.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

1. A hygiene washing system comprising:
a mixing pod, the mixing pod further comprising
a mixing pod housing having an interior chamber, a mixing pod inlet, and a mixing pod outlet,
a mixing pod controller,
a venturi injector in communication with a mixing pod valve, and
an insertion member operable to insert a concentrate into the interior chamber;
a fluid applicator, the fluid applicator further comprising
a body having a fluid applicator length, a fluid applicator width, a fluid applicator thickness, and a fluid receiving aperture wherein the fluid applicator length is greater than the fluid applicator width,
a tubular member in fluid communication with the mixing pod and the body, and
a fluid delivery aperture operable to deliver fluid from the fluid applicator when a fluid applicator controller is engaged; and
an adapter, wherein the adapter is operable to connect the mixing pod to a water source.

2. The hygiene washing system of claim 1 wherein the fluid applicator has an overall 3-dimensional rectangular shape with curved sides.

3. The hygiene washing system of claim 1 wherein the tubular member is unidirectional.

4. The hygiene washing system of claim 1 wherein the fluid delivery aperture is a triangular aperture with concave sides.

5. The hygiene washing system of claim 1 wherein fluid applicator controller fits within a channel in the fluid applicator aperture.

6. The hygiene washing system of claim 1 wherein the body further comprises a front piece and a housing back piece wherein the front piece and the back piece have a snap-fit arrangement.

7. The hygiene washing system of claim 1 wherein the body further comprises an inlet in communication with the tubular member.

8. The hygiene washing system of claim 1 wherein the body further comprises a magnet.

9. The hygiene washing system of claim 1 further comprising a dryer operable to deliver air via at least one of the fluid delivery aperture and an air delivery aperture.

10. The hygiene washing system of claim 1 further comprising a power source.

11. The hygiene washing system of claim 10 wherein the power source is at least one of a battery and a turbine.

12. The hygiene washing system of claim 1 further comprising a heater operable to heat fluid prior to delivery via the fluid delivery aperture.

13. The hygiene washing system of claim 1 further comprising an adapter operable to connect a water supply line to the mixing pod.

14. The hygiene washing system of claim 13 wherein the adapter further comprises a female adapter attachment with an inlet screw knob, a male adapter attachment, and a valve state indicator.

15. The hygiene washing system of claim 1 further comprising a docking station for the fluid applicator having a housing with a front surface and a rear surface.

16. The hygiene washing system of claim 15 wherein the docking station further comprises a docking station magnet.

17. The hygiene washing system of claim 15 above wherein the docking station further comprises a securement interface on the rear surface of the housing.

18. The hygiene washing system of claim 1 wherein the fluid applicator further comprises a fluid applicator controller aperture along a portion of the fluid applicator length having a fluid applicator aperture width sized to receive a digit of a user.

19. The hygiene washing system of claim 18 wherein a fluid applicator controller is accessible in the fluid applicator controller aperture and further wherein the fluid applicator controller moves in a proximal direction when activated by the user.

20. A mixing pod comprising:
a mixing pod housing having an interior chamber, a mixing pod inlet, and a mixing pod outlet,
a mixing pod controller,
a venturi injector in communication with a mixing pod valve, and
an insertion member operable to insert a concentrate into the interior chamber.

21. The mixing pod of claim 20 further comprising a heater operable to heat fluid.

22. The mixing pod of claim 20 wherein the mixing pod maintains a fluid at a room temperature.

23. The mixing pod of claim 20 wherein the mixing pod housing further comprises a mixing pod cap, a mixing pod chamber, and a mixing pod base.

24. The mixing pod of claim 23 wherein the mixing pod base has a column and the mixing pod chamber has a center tubular member and further wherein the mixing pod column is configured to fit within the center tubular member.

25. The mixing pod of claim 24 wherein the tubular member is operable to receive one or more tubings.

26. The mixing pod of claim 23 wherein the mixing pod base has a base inlet aperture and a base outlet aperture and the mixing pod chamber has a chamber inlet aperture and a chamber outlet aperture and further wherein the base inlet aperture aligns with the chamber inlet aperture and the base outlet aperture aligns with the chamber outlet aperture.

27. A fluid applicator comprising:
a body having a fluid applicator length, a fluid applicator width, a fluid applicator thickness, and a fluid receiving aperture wherein the fluid applicator length is greater than the fluid applicator width wherein the fluid applicator is in fluid communication with a fluid source, and
a fluid delivery aperture operable to deliver fluid from the fluid applicator when a fluid applicator controller is engaged wherein the fluid delivery aperture is a triangular aperture with concave sides.

28-45 (canceled)

46. A method of installing a washing system comprising:
providing the washing system wherein the washing system comprises a mixing pod, the mixing pod further comprising a mixing pod housing having an interior chamber, a mixing pod inlet, and a mixing pod outlet, a mixing pod controller, a venturi injector in communication with a mixing pod valve, and an insertion member operable to insert a concentrate into the interior chamber; a fluid applicator, the fluid applicator further comprising a body having a fluid applicator length, a fluid applicator width, a fluid applicator thickness, and a fluid receiving aperture wherein the fluid applicator length is greater than the fluid applicator width, a tubular member in fluid communication with the mixing pod and the body, and a fluid delivery aperture operable to deliver fluid from the fluid applicator when a fluid applicator controller is engaged; and an adapter, wherein the adapter is operable to connect the mixing pod to a water source.
connecting the adapter to a water supply; and
connecting the adapter to the mixing pod.

47. (canceled)

48. A method of using a fluid applicator comprising:
providing the fluid applicator wherein the fluid applicator comprises a body having a fluid applicator length, a fluid applicator width, a fluid applicator thickness, and a fluid receiving aperture wherein the fluid applicator length is greater than the fluid applicator width wherein the fluid applicator is in fluid communication with a fluid source, and a fluid delivery aperture operable to deliver fluid from the fluid applicator when a fluid applicator controller is engaged wherein the fluid delivery aperture is a triangular aperture with concave sides;
directing the fluid delivery aperture toward a target area selected from genitalia, perineum and anus; and
activating the fluid applicator to deliver a fluid to the target area.

49. (canceled)

50. A washing system kit comprising:
a mixing pod, the mixing pod further comprising
a mixing pod housing having an interior chamber, a mixing pod inlet, and a mixing pod outlet,
a mixing pod controller,
a venturi injector in communication with a mixing pod valve, and
an insertion member operable to insert a concentrate into the interior chamber;
a fluid applicator, the fluid applicator further comprising
a body having a fluid applicator length, a fluid applicator width, a fluid applicator thickness, and a fluid receiving aperture wherein the fluid applicator length is greater than the fluid applicator width,
a tubular member in fluid communication with the mixing pod and the body, and
a fluid delivery aperture operable to deliver fluid from the fluid applicator when a fluid applicator controller is engaged; and
an adapter, wherein the adapter is operable to connect the mixing pod to a water source.

51-57 (canceled)
